(19) United States
(12) Patent Application Publication
(10) Pub. No.: US 2023/0206105 A1
(43) Pub. Date: Jun. 29, 2023

(54) SYNCHRONIZATION SYSTEM FOR QUANTUM NETWORKS

(71) Applicant: California Institute of Technology, Pasadena, CA (US)

(72) Inventors: Maria Spiropulu, Pasadena, CA (US); Lautaro Narváez, Pasadena, CA (US); Venkata Ramana Raju Valivarthi, Pasadena, CA (US)

(73) Assignee: California Institute of Technology, Pasadena, CA (US)

(21) Appl. No.: 18/074,112

(22) Filed: Dec. 2, 2022

Related U.S. Application Data
(60) Provisional application No. 63/357,505, filed on Jun. 30, 2022.
(60) Provisional application No. 63/285,483, filed on Dec. 2, 2021.

(51) Int. Cl. G06N 10/40; H04B 10/70; G01N 21/65

(52) U.S. Cl. CPC G06N 10/40; H04B 10/70; G01N 21/65

(57) ABSTRACT

A synchronization system for synchronizing photons in a quantum teleportation network. The synchronization system includes a multiplexer combining a clock pulse with a signal photon (carrying a qubit) in an optical fiber, the optical fiber connecting a transmitter node (including the multiplexer) and a receiver node (comprising a demultiplexer). The signal photons have signal wavelengths red shifted as compared to clock wavelengths of the clock pulses. The clock pulses have an intensity below a threshold, such that Raman scattering of the clock pulses by the fiber (shifting the clock wavelengths into the signal wavelengths) is negligible. The receiver node comprises a demultiplexer demultiplexing the one of the signal photons and the one of the clock pulses; a first detector detecting the one of the signal photons; and a second detector detecting the one of the clock pulses.

### CROSS REFERENCE TO RELATED APPLICATIONS

This application claims the benefit under 35 U.S.C. Section 119(e) of the following co-pending and commonly-assigned applications:

U.S. Provisional Patent Application No. 63/285,483, filed Dec. 2, 2021, by Maria Spiropulu and Venkata Ramana Raju Valivarthi, entitled “SYNCHRONIZATION SYSTEM FOR QUANTUM NETWORKS” Attorney's Docket No. 176.187-US-P1; and

U.S. Provisional Patent Application No. 63/357,505, filed Jun. 30, 2022, by Maria Spiropulu and Venkata Ramana Raju Valivarthi, entitled “SYNCHRONIZATION SYSTEM FOR QUANTUM NETWORKS” Attorney's Docket No. 176.187-US-P2 (2019-400-1);

both of which applications are incorporated by reference herein.

This application is related to U.S. patent application Ser. No. 18/073,245 filed Dec. 1, 2022, by Maria Spiropulu and Venkata Ramana Raju Valivarthi, entitled “TELEPORTATION SYSTEMS TOWARD A QUANTUM INTERNET,” which application claims the benefit under 35 USC 119(e) of co-pending and commonly assigned U.S. Provisional Patent Application Ser. No. 63/285,782, filed Dec. 3, 2021, by Maria Spiropulu and Venkata Ramana Raju Valivarthi, entitled “TELEPORTATION SYSTEMS TOWARD A QUANTUM INTERNET,” (CIT-8635), both of which applications is incorporated by reference herein.

### STATEMENT REGARDING FEDERALLY SPONSORED RESEARCH AND DEVELOPMENT

This invention was made with government support under Grant No. DE-SC0019219 and DE-SC0020376 awarded by US Department of Energy. The government has certain rights in the invention.

### BACKGROUND OF THE INVENTION

### 1 Field of the Invention

The present invention relates to synchronization systems for quantum teleportation networks and methods of implementing the same.

### 2. Description of Related Art

(Note: This application references a number of different references as indicated throughout the specification by one or more reference numbers in brackets, e.g., [x]. A list of these different publications ordered according to these reference numbers can be found below in the section entitled “References.” Each of these references is incorporated by reference herein.)

Quantum networks that distribute qubits encoded using photons may be identified at each node in the network by recording their times of generation and detection with respect to a various node clocks. However, environment-induced variations in the length of fiber optics cables (causing variations in the recording times) can lead to misidentification of photons.

Using a single fiber for both the clock synchronization and quantum signals makes better use of the limited optical fiber infrastructure that can be employed for quantum communication. The challenge with this setting is ensuring that the strong optical pulses used for synchronization do not introduce noise that reduces the fidelity of the transmitted qubits. The leading source of noise in optical fiber channels is due to off-resonant Raman scattering of the clock pulses, which produces significantly more red-shifted than blue-shifted light [7]. Typical methods to mitigate this involve strong temporal and spectral filtering [8] or using photons that are significantly blue shifted from the clock pulses [1]. Accordingly, there is little work to investigate the role of the Raman noise when photons are red-shifted from the clock pulses and both are in the same fiber, in particular if the photons and the clock pulses are at wavelengths within the standard fiber telecommunication windows, and if such noise prohibits reaching ps-scale timing resolution of the clock distribution system.

### SUMMARY OF THE INVENTION

Example systems, methods, or devices according to the present invention include, but are not limited to, the following.
1. A system for synchronizing photons (for example, in a communications link or network, such as, but not limited to, a quantum teleportation network or a hybrid telecommunication network, e.g. linked by fibers) comprising:

a transmitter node comprising:

a photon source outputting signal photons used to teleport one or more qubits, wherein the signal photons comprise one or more first wavelengths;

a transmitter clock outputting one or more clock pulses comprising electromagnetic radiation having one or more second wavelengths, wherein the one or more first wavelengths are red shifted as compared to the one or more second wavelengths; and

a multiplexer distributing at least one multiplexed signal, comprising one of the signal photons and one of the clock pulses, to at least one fiber for transmission to at least one receiver node (e.g., in the communications network or link), wherein the clock pulses comprise an intensity below a threshold such that Raman scattering of the one of the clock pulses by the at least one fiber, shifting the one or more second wavelengths to the one or more first wavelengths of the one of signal photons, is negligible or suppressed, and

the at least one receiver node comprising:
a demultiplexer demultiplexing the one of the signal photons and the one of the clock pulses;
a first detector detecting the one of the signal photons; and
a second detector detecting the one of the clock pulses.
2. The system of example 1, wherein the at least one receiver node comprises:

a circuit detecting a time difference between:
a first arrival time of the one of the signal photons detected by the first detector, and
a second arrival time of the one of the clock pulses detected by the second detector; and

a receiver clock synchronizing to the transmitter clock using the time difference.
3. The system of example 2, wherein receiver node further comprises:

a spectral filter purifying the one of the signal photons by removing spectral correlations, so as to form a purified photon enabling two photon interference of the purified photon with an additional photon, as characterized by observation of a Hong-Ou-Mandel effect or performance of a Bell State Measurement; and

the first detector comprises a single photon detector detecting the purified photon and outputting a signal electrical pulse in response thereto.
4. The system of example 3, wherein the receiver node further comprises:

the second detector comprising a photodiode outputting an electrical signal in response to detecting the one of the clock pulses;

an amplifier amplifying the electrical signal;

a voltage oscillator connected to the amplifier so that the electrical signal adjusts a phase of the voltage oscillator outputting a clock electrical pulse; and

a time to digital converter circuit determining the time difference between the signal electrical pulse and the clock electrical pulse.
5. A data acquisition and control system connected to the transmitter node and the receiver node of example 2 for logging the time difference.
6. The system of example 1, comprising:

a plurality of the at least one fiber (hereinafter fibers) connecting the transmitter node to a plurality of the at least one receiver node (hereinafter receiver nodes), wherein the at least one multiplexer distributes a plurality of the at least one multiplexed signal (hereinafter multiplexed signals), each of the multiplexed signals distributed to a different one of the fibers connecting between the transmitter node and a different one of the receiver nodes.
7. The system of example 1, further comprising:

the at least one fiber comprising:

a first fiber connecting the transmitter node to the at least one receiver node comprising a first receiver node, and

a second fiber connecting the transmitter node to the at least one receiver node comprising a second receiver node,

the at least one multiplexed signal comprising a first multiplexed signal transmitted in the first fiber and a second multiplexed signal transmitted in the second fiber; and

the signal photons comprising entangled photons comprising a first entangled photon entangled with a second entangled photon, wherein the one of the signal photons in the first multiplexed signal comprises the first entangled photon and the one of the signal photons in the second multiplexed signal comprises the second entangled photon.
8. A teleportation system, quantum link, or quantum network comprising the system of example 7, wherein at least one of the transmitter node, the first receiver node, or the second receiver node comprise a two-photon interferometer for interfering the first entangled photon or the second entangled photon, carrying one of the qubits, with another photon carrying another qubit, so as to perform a Bell State Measurement.
9. A pulse shortener, comprising:

a first comparator comparing an input pulse, having a FWHM in a range of 1-100 ns, with a threshold so as to output:

a first signal if the input pulse has a greater amplitude than the threshold, or

a second signal if the input pulse has a smaller amplitude than the threshold;

a second comparator and a third comparator connected to the first comparator, wherein the second comparator outputs a first polarity signal in response to the first signal and the third comparator outputs a second polarity signal in response to the second signal, wherein the first polarity signal and the second polarity signal have equal magnitude but opposite polarity;

a variable delay line connected to the second comparator and the third comparator, wherein the variable delay line combines the first polarity signal and the second polarity signal with variable overlap to form an output pulse; and

an AND gate connected to the variable delay line, wherein the AND gate has a rise and fall time of less than 10 ps modulating the output pulse to form a shortened pulse having a full width at a half maximum in a range of 25 ps≤FWHM≤100 ps.
10. One or more amplifiers, each of the amplifiers comprising:

differential inputs, comprising a first input and a second input; and

a single output; and wherein:

the each of the amplifiers is configured to amplify an electrical pulse having a duration D in a range of 1≤D≤1000 ps, received at the first input, into a modulation voltage pulse at the single output, and

the modulation voltage pulse has a FWHM less than 100 ps and an amplitude comprising a pi voltage of a Mach Zehnder Modulator (MZM).
11. A chip comprising a plurality of the amplifiers of example 10, comprising the differential inputs and a plurality of the single outputs, wherein each of the single outputs output the modulation voltage pulse in response to the electrical pulse received at the first input.
12. A driver circuit for driving multiple Mach Zehnder Modulators (MZM), comprising:

one or more printed circuit boards comprising:

the amplifiers of example 11,

one or more power supplies for powering the driver circuit;

a current monitoring system, an analog to digital converter, and a digital to analog converter for controlling a gain, a zero-voltage crossing, and an undershoot of the electrical pulse;

a plurality of output tracks for connecting each of the single outputs to a different one of the MZMs;

two input tracks for connecting to the first input and the second input.
13. An entangled photon pair source (PPS), comprising:

a PPS clock outputting a PPS clock pulse;

a pulse shortener shortening a duration the PPS clock pulse so as to form a shortened pulse having a FWHM of less than 100 ps;

an amplifier amplifying the shortened pulse to an amplitude corresponding to a desired modulation voltage of a Mach Zehnder Modulator (MZM);

the MZM coupled to the amplifier and a CW laser outputting continuous wave (CW) electromagnetic radiation, wherein the modulation voltage applied to the MZM controls modulation of continuous (CW) electromagnetic radiation by the MZM to form picosecond pulses of the electromagnetic radiation having a duration D in a range of 1≤D≤100 ps; and

a non-linear crystal outputting entangled photons in response to each of the picosecond pulses.
14. The entangled photon pair source of example 13, wherein the pulse shortener comprises:

a first comparator comparing an input pulse, having a full width at half maximum (FWHM) in a range of 1-100 nanoseconds, with a threshold so as to output:

a first signal if the input signal has a greater amplitude than the threshold, or

a second signal if the input signal has a smaller amplitude than the threshold;

a second comparator and a third comparator connected to the first comparator, wherein the second comparator outputs a first polarity signal in response to the first signal and the third comparator outputs a second polarity signal in response to the second signal, wherein the first polarity signal and the second polarity signal have equal magnitude but opposite polarity;

a variable delay line connected to the second comparator and the third comparator, wherein the variable delay line combines the first polarity signal and the second polarity signal with variable overlap to form an output pulse; and

an AND gate connected to the variable delay line, wherein the AND gate has a rise and fall time of less than 10 ps modulating the output pulse to form a shortened pulse having a full width at a half maximum in a range of 25 ps≤FWHM≤100 ps.
15. The entangled photon pair source of example 14, wherein the amplifier comprises:

differential inputs, comprising a first input and a second input; and

a single output; and wherein:

the amplifier is configured to amplify an electrical pulse having a duration D in a range of 1≤D≤1000 ps, received at the first input, into a modulation voltage pulse at the single output, and

the modulation voltage has a FWHM less than 100 ps and an amplitude comprising a pi voltage of a Mach Zehnder Modulator (MZM).
16. The system of example 1, wherein the photon source comprises an entangled photon pair source comprising:

a PPS clock outputting a PPS clock pulse;

a pulse shortener shortening a duration the PPS clock pulse so as to form a shortened pulse having a FWHM of less than 100 ps;

an amplifier amplifying the shortened pulse to an amplitude corresponding to a desired modulation voltage of a Mach Zehnder Modulator (MZM);

the MZM coupled to the amplifier and a CW laser outputting continuous wave (CW) electromagnetic radiation, wherein the modulation voltage applied to the MZM controls modulation of the CW electromagnetic radiation by the MZM to form picosecond pulses of the electromagnetic radiation having a duration D in a range of 1≤D≤100 ps; and

a non-linear crystal outputting entangled photons in response to each of the picosecond pulses.

and the transmitter clock comprises the PPS clock.
17. The system of example 16, wherein the amplifier comprises:

differential inputs, comprising a first input and a second input; and

a single output; and wherein:
the amplifier is configured to amplify an electrical pulse having a duration D in a range of 1≤D≤1000 ps, received at the first input, into a modulation voltage pulse at the single output, and
the modulation voltage pulse has a FWHM less than 100 ps and an amplitude comprising a pi voltage of a Mach Zehnder Modulator (MZM); and the pulse shortener comprises:

a first comparator comparing an input pulse, having a FWHM in a range of 1-100 ns, with a threshold so as to output:

a first signal if the input signal has a greater amplitude than the threshold, or

a second signal if the input signal has a smaller amplitude than the threshold;

a second comparator and a third comparator connected to the first comparator, wherein the second comparator outputs a first polarity signal in response to the first signal and the third comparator outputs a second polarity signal in response to the second signal, wherein the first polarity signal and the second polarity signal have equal magnitude but opposite polarity;

a variable delay line connected to the second comparator and the third comparator, wherein the variable delay line combines the first polarity signal and the second polarity signal with variable overlap to form an output pulse; and an AND gate connected to the variable delay line, wherein the AND gate has a rise and fall time of less than 10 ps modulating the output pulse to form a shortened pulse having a full width at a half maximum in a range of 25 ps≤FWHM≤100 ps.
18. The system of example 1, wherein the signal photons comprise the first wavelengths in a telecommunications C band and the clock pulses comprise the second wavelengths in a telecommunications 0 band.
19. The system of example 1, wherein the Raman scattering is suppressed such that a timing jitter of clocks in the different nodes is, or the transmitter clock and receiver clocks in the receiver nodes are synchronized to, within 5 picoseconds or less and/or the signal photons can be correctly identified using the clock pulses.
20. The system of example 2, wherein the circuit detects the time difference so that the time difference can be determined with an accuracy of 10 picoseconds or less.
21. A fiber based quantum network comprising three-nodes and that is supported by a low-noise, scalable, and automated clock distribution system. This is realized by distributing photon pairs in the telecommunication C-band (1.5 μm) simultaneously with strong optical “clock” pulses in the telecommunication O-band (1.3 μm) in the same fiber. Specifically, light is distributed from a central node over two 11 km-length fibers to two end nodes. The pulses used for clock distribution are created by bias switching a laser diode whereas the pulses generating the photon pairs through spontaneous parametric down-conversion (SPDC) are carved from a continuous-wave laser by a Mach-Zehnder modulator. Our setup uses in-house, high-bandwidth, and scalable electronics to generate 3.7 V (peak-to-peak) pulses having near-Gaussian distributions with durations as low as 47 ps and sub-ps timing jitter. The effect of Raman scattering, characterized by measuring the coincidence-to-accidental ratio [symbol] of the distributed photon pairs using a free-running data acquisition and control system, is reduced from [symbol] =77±14 to 42±2, which is still sufficient for high high-fidelity qubit distribution. Furthermore, we observe only 2 ps of timing jitter (over 1 minute of integration) between clocks at the central and end nodes, suggesting our method can be used for high rate networks.

### BRIEF DESCRIPTION OF THE DRAWINGS

Referring now to the drawings in which like reference numbers represent corresponding parts throughout:

FIG. 1. Concept of a clock distribution system for a three-node quantum network. A clock is used to generate pulses (top hats) at a central node (node 1) that are distributed to end nodes (nodes 2 and 3) by fiber channels (grey lines) where they are detected (DET) and used to lock the phase of clocks at the end nodes. Simultaneously, light (Gaussians) from a photon pair source (PPS) at the central node is directed into the same fiber towards single photon detectors (SPDs) at the end nodes. Data acquisition (DAQ) systems record the arrival times of the photons with respect to the phase of the clocks at the end nodes, thereby ensuring the clocks are synchronized with the photons.

FIG. 2. Schematic of fiber-based three-node quantum network and synchronization system. See main text for description. Clock pulses are indicated by top hats whereas grey and red Gaussian-shaped pulses indicate light of 1536 nm and 768 nm wavelength, respectively. The loss contributions from each fiber spool is 2.26 dB and 2.8 dB, respectively, whereas each WDM and FBG adds 2 dB and 6 dB of loss, respectively.

FIG. 3. TOP: User interface to control the parameters of the mezzanine and Picoamp amplifier chip. The interface displays the voltages and currents that are used to vary the pulse shape. BOTTOM: Picoshort pulse shortener board. The Picoshort receives a standard differential pulse and outputs a differential pulse as short as 25 ps. A: input discriminator, B,B′: pair of discriminators with opposite logic output. C,C′: variable delay lines. D: AND gate.

FIG. 4A. A 25 ps-duration differential output pulse from the Picoshort pulse shortener. FIG. 4B: A 47 ps-duration, 1.88 Vp-p, output pulse from the Picoamp amplifier.

FIG. 4C: Attenuated optical pulse measured after the MZM using an SNSPD. Pulse duration is 74 ps and has an extinction ratio of 28 dB. Time is measured relative to the maximum amplitude of the pulse.

FIG. 5. PLOT: Frequency response of the Picoamp differential-to-single-ended amplifier. RIGHT: Picoamp broadband differential-to-single-ended amplifier. LEFT: Mezzanine board for the Picoamp. It provides closed-loop control of the current and voltages and remote control of the tuning parameters via the interface shown in FIG. 3. the frequency response s₂₁ of one of its channels using a vector-network analyzer (FIG. 5). We find a 3 dB-bandwidth of 10 GHz and a gain of more than 30 dB at low frequencies (<1 GHz), which is sufficient for amplifying pulses from the Picoshort. The frequency-dependent modulation is likely due to resonances produced by imperfections in the board manufacturing, including track placement and connectors.

FIG. 6. Coincidence histogram without any clock distribution system enabled.

FIG. 7. Coincidence histogram by distributing optical clock pulses (red) or electronic pulses, with the optical clock pulses blocked (blue). The small time delay between the histograms is due a small difference in trigger voltage threshold. Inset is plotted on a log scale to clearly reveal noise from the optical clock pulses.

FIG. 8A. Variation of the time difference between the arrival of clock pulses at Rx1 and Rx2 over 7 h. The maximum time difference is 5 ps due to fiber length variations. FIG. 8B: histogram of the time difference over a 900s time scale indicates a timing jitter of 2 ps.

FIG. 9 is a flowchart illustrating a method of making a synchronization system.

FIG. 10 is an example classical computer environment for implementing one or more methods described herein.

FIG. 11 is an example network environment for implementing one or more methods described herein.

FIG. 12 is a flowchart illustrating a method of making a pulse shortener.

FIG. 13A is a flowchart illustrating a method of making an amplifier and FIG. 13B is a schematic of an amplifier.

FIG. 14 is a flowchart illustrating a method of making a driver circuit.

FIG. 15 is a flowchart illustrating a method of making an entangled photon pair source.

FIG. 16 is an example quantum link or quantum teleportation network which may comprise, utilize, or be coupled to the synchronization system.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized, and structural changes may be made without departing from the scope of the present invention.

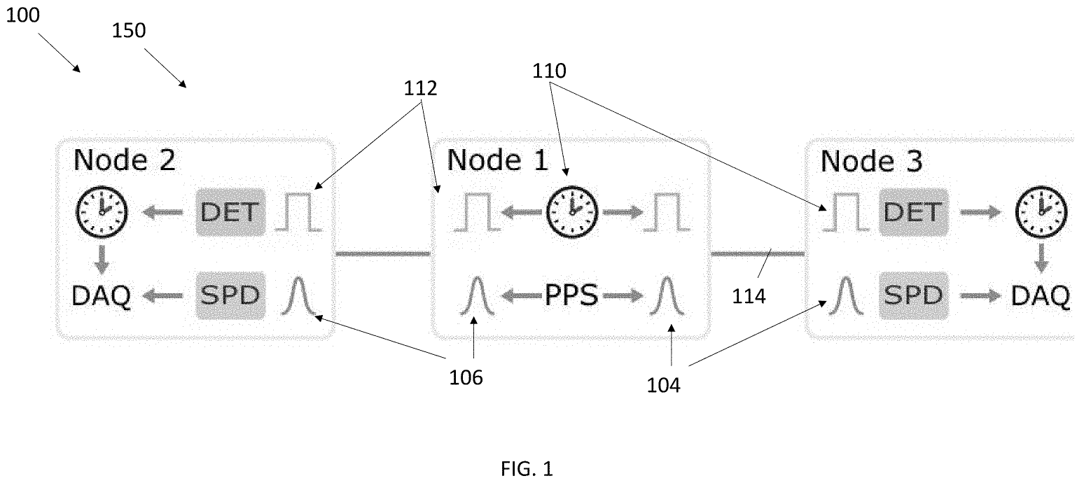

Technical Description FIG. 1 illustrates a system accounting for synchronizing photons in a network by adjusting the phases of each local clock based on a centrally located primary clock and distributing clock optical pulses between the nodes. These pulses can be distributed jointly through the same fiber that is carrying the single-photon level quantum signal. This type of clock distribution method, which can be utilized in quantum networking demonstrations [1], [2], [3], [4], [5], [6], allows synchronization between all local clocks, and hence identification of photons throughout the network. Moreover, this method enables operation of the network at a high clock-rate and the possibility to perform linear-optic Bell-state measurements based on two-photon interference, which requires precise synchronization of photons.

### First Example: Synchronization System

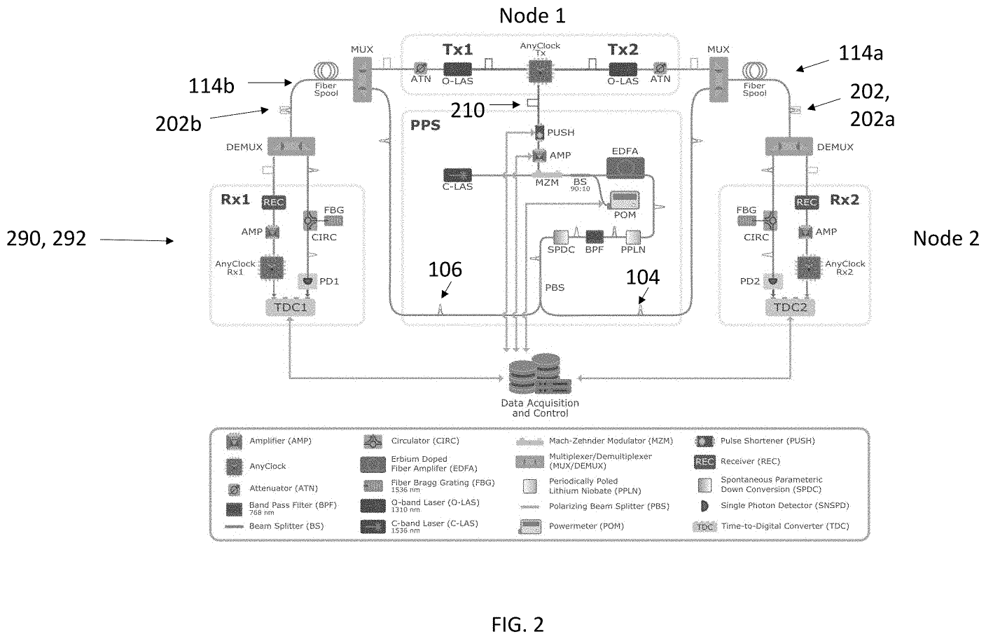

FIG. 2 illustrates a three-node quantum network and corresponding synchronization system, comprising electronics, single-photon detectors, and fiber-based components. The central node consists of a photon pair source (PPS) operating at the telecommunication C-band wavelength of 1536 nm and two transmitters (Tx1, Tx2) generating clock pulses at the telecommunication O-band wavelength of 1310 nm. By way of wavelength division multiplexer/demultiplexers (MUX/DEMUXs), the clock pulses and single photons are directed into fibers and distributed to end nodes via (in this example, 11 km-length) spools of single mode fiber. At the end nodes, the clock pulses and photon pairs are separated using DEMUXs and subsequently detected (Rx1, Rx2). As described in detail below, in this example, synchronization of the photon pair generation and detection events is ensured by (i) generating a photon pair synchronously with a clock pulse and (ii) recording the time between the detection of the clock pulse and the individual photon at each end node.

FIG. 2 illustrates clock distribution is seeded by a clock (in this example, comprising a 200 MHz voltage oscillator) (AnyClockTx) at the central node. The clock generates 2.5 ns-duration pulses that are used to bias switch two 0-band laser diodes (O-LASs), generating optical clock pulses of similar duration which are subsequently attenuated (in this example, to an average power of 0.25 mW). This setup is indicated by Tx1 and Tx2 in FIG. 2. Synchronous with the optical clock pulse generation, AnyClockTx creates a third pulse which is shortened, in this example, to a duration as low as 47 ps (PUSH) and power-amplified by up to 28 dB (AMP) using electronics described in the second example, then directed to, in this example, a 20 GHz-bandwidth fiber-coupled Mach-Zehnder modulator (MZM) within the PPS setup. The pulse amplitudes approximately correspond to the π-voltage of the MZM. The PPS setup contains a C-band laser (C-LAS) emitting continuous-wave light of 1536 nm wavelength that is modulated using the MZM to create, in this example, 74 ps —duration optical pulses with an extinction ratio of 28 dB at a (clock synchronized) repetition rate of 200 MHz. After passing a 90:10 beam splitter used for monitoring (POM) the stability of the MZM, these pulses are amplified by an erbium-doped fiber amplifier (EDFA), producing pulses with average power of, in this example, 100 mW, and then directed to a fiber-packaged periodically poled lithium niobate (PPLN) waveguide which up-converts the light to, in this example, 768 nm wavelength. Next, the residual 1536 nm light is removed using a band-pass filter (BPS) and the pulses are directed to a second PPLN waveguide configured to produce the 1536 nm-wavelength photon pairs by Type-II SPDC. A fiber based polarizing beam splitter (PBS) separates each photon from the pair into different fibers, where they are each directed to the MUXs, and combined with the optical clock pulses in the fiber spools.

At the end nodes, after passing the DEMUXs, the individual photons are filtered by fiber Bragg gratings (FBGs), by way of circulators (CIRC), to a bandwidth of 2.5 GHz (in this example), and detected using cryogenically cooled superconducting nanowire single photon detectors (SNSPDs) with (in this example, 50 ps timing jitter) (PD1 and PD2). The electrical pulses generated by the SNSPDs are directed to time-to-digital converters (TDC1, TDC2). The optical clock pulses are received by 200 MHz—bandwidth (for example) amplified photodiodes (REC) which generate electrical pulses that are amplified (AMP) by 15 dB using scalable electronics (described in the second example). These pulses adjust the phase of the 200 MHz voltage oscillators (AnyClockRx1, AnyClockRx2) at the end nodes which produce pulses that are detected by the TDCs. The TDCs then record the time difference between the electrical pulses generated by the SNSPDs and the oscillators to verify the synchronization. This time difference is logged using a scalable data acquisition and monitoring system (indicated in FIG. 2) that enables uninterrupted quantum networking for an extended time duration (>days).

### Second Example: Pulse Shortener and Amplifier Electronics

Pulsed quantum networking experiments typically use either mode-locked lasers [3] or laser diodes and modulators, such as MZMs, driven by electrical pulses [9] generated from arbitrary waveform generators [10] and off-the-shelf multipurpose amplifiers [11]. These approaches are expensive, bulky, and not scalable to multi-node quantum networks. The present invention addresses these shortcoming using pulse (duration) shorteners and amplifiers, referred to as Picoshort and Picoamp modules, respectively, that shape electrical pulses from the AnyClockTx oscillator, see FIG. 2. The resulting pulses are used to drive the MZM to its π-voltage, producing high-extinction pulses (>20 dB) for the PPS. Short-duration (<100 ps) pulses allow the possibility of measuring high signal-to-noise ratios, the ability to create time-bin qubits in a single clock event (by splitting the pulse into two), and the realization of photon pairs with high spectral purity. As shown in FIG. 2, the Picoamp can also be used to increase the output voltage of the REC photodiodes for compatibility with the AnyClockRx oscillators.

### a. Example Pulse Shortener (Picoshort)

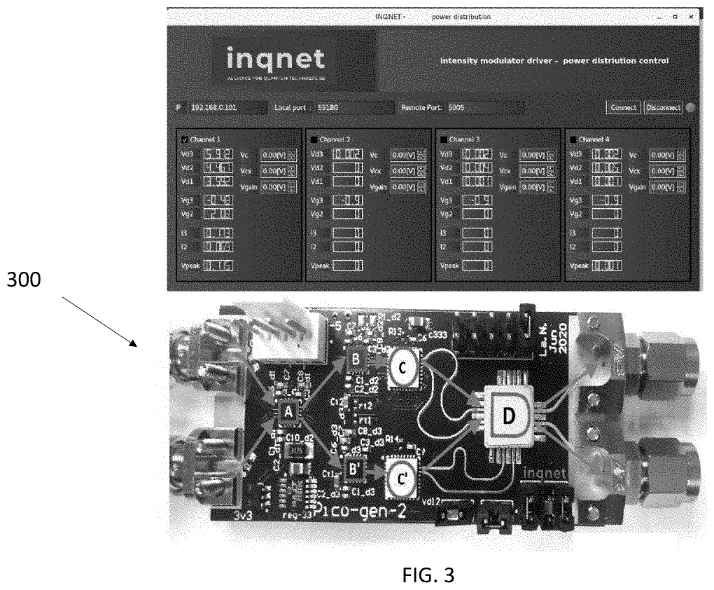

The example pulse shortener comprises an AND gate combined with a variable delay line. This produces electrical pulses with short (<100 ps) and tunable (e.g. from few to hundreds of ps) durations [12]. FIG. 3 illustrates a circuit to shorten the 5 ns-duration pulses from the AnyClockTx oscillator. The input pulses are fed to a comparator (A) which produces differential digital signals with respect to a threshold. These signals are then directed to two comparators (B and B′) which output differential digital signals with amplitudes that only differ in polarity. These pulses are then sent to two high bandwidth programmable variable delay lines (C and C′) which have a resolution of 3 ps and a dynamic range of 100 ps, allowing the output pulse duration to be tuned. The output pulses are then directed to an AND gate (D), which has a rise and fall time of 10 ps, thereby limiting the pulse duration to be no less than ˜25 ps.

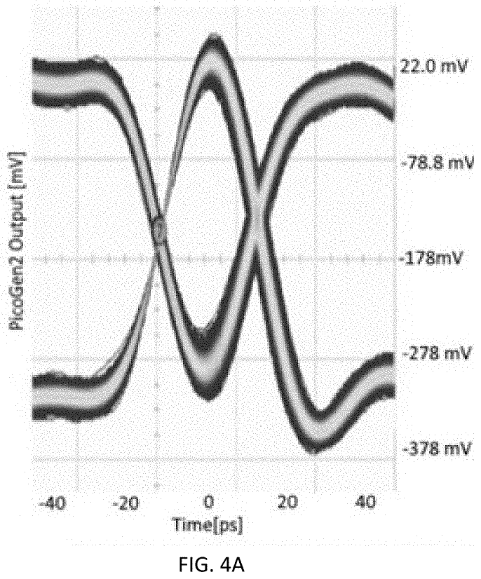

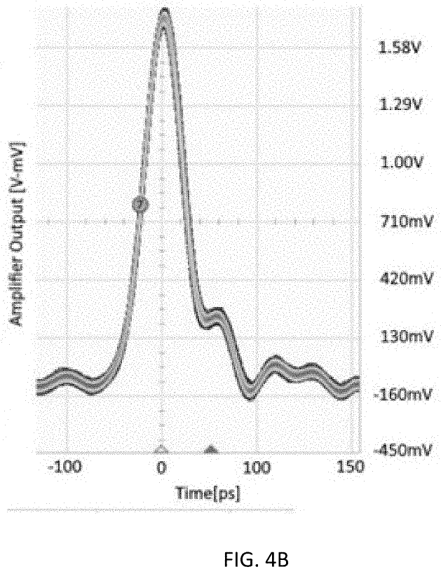

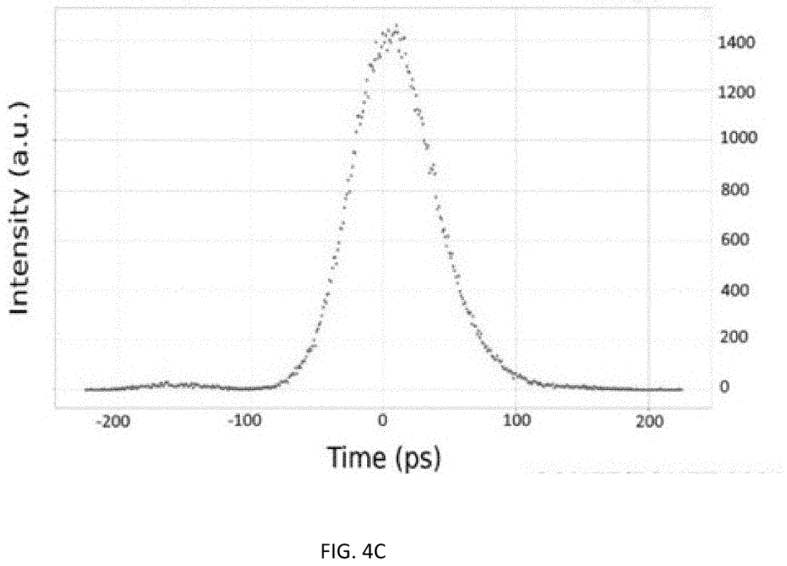

Using an input pulse from the AnyClockTx, the shortest duration output pulse from the Picoshort is measured using an oscilloscope, as shown in FIG. 4 as a differential signal. The full-width-at-half-maximum (FWHM) of the pulses is 24.8 ps and 24.5 ps for the positive- and negative-going differential signals, whereas their amplitudes are 270 mV and 299 mV, respectively.

### b. Pulse Amplifier (Picoamp)

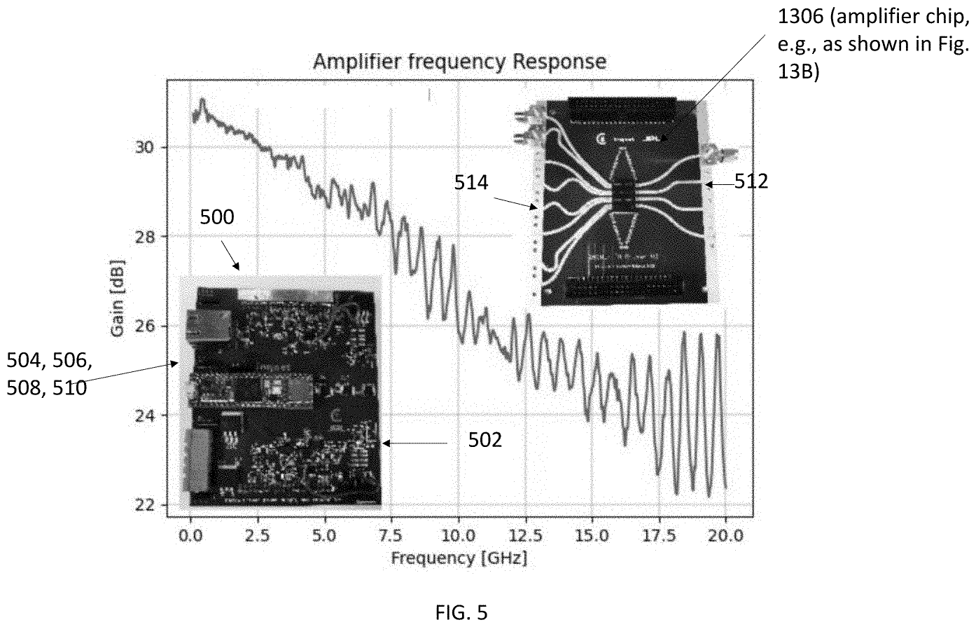

Amplification of the pulses from the Picoshort module is required, in the configuration of FIG. 2, to reach the ˜4 Vπ-voltage of the MZM to produce optical pulses of <100 ps duration. FIG. 5 illustrates a high-bandwidth differential-to-single-ended radiofrequency amplifier board, the Picoamp which can be used for this amplification. A single board is able to drive four modulators simultaneously, allowing compact and inexpensive use in a future multi-node network or situations in which multiple modulators are required for generating the quantum signal [13], [2]. FIG. 5 further illustrates an accompanying voltage biasing system on a mezzanine board. The mezzanine board design facilitates seamless integration of the control software (screenshot shown at the top of FIG. 3) with the Picoamp for remote operation. The mezzanine and amplifier boards consist of several power supplies, current monitoring systems, analog-to-digital as well as digital-to-analog converters, and control the gain, zero-voltage crossing point, as well as the undershoot of the output pulses.

The performance of the picoamp is characterized by first measuring the frequency response (S₂₁) of one of its channels using a vector-network analyzer (FIG. 5). We find a 3 dB-bandwidth of 10 GHz and a gain of more than 30 dB at low frequencies (<1 GHz), which is sufficient for amplifying pulses from the Picoshort. The frequency-dependent modulation is likely due to resonances produced by imperfections in the board manufacturing, including track placement and connectors.

Next, the 25 ps-duration pulse (shown on FIG. 4A) from the Picoshort is amplified and, after optimizing for undershoot, voltage crossings, etc., measured using an oscilloscope, with the result shown on FIG. 4B. The amplitude and FWHM of the pulse are found to be 3.76 V and ˜47 ps, respectively, whereas the timing jitter of the pulse remains less than 1 ps. The modulated tail of the pulse is likely due to small impedance mismatches within the Picoamp board. Note that we measure similar timing jitters when using a Picoamp for increasing the voltage of pulses from the REC photodiode (FIG. 2).

The MZM of FIG. 2 can also be driven with the output pulse from a Picoamp. For this step, output optical pulses after the MZM are measured by attenuating and directing them to an SNSPD, see FIG. 4C. We find an optical pulse duration of 74 ps with an extinction ratio of 28 dB, with the slight pulse broadening owing to the ringing on the tail end of the pulse output from the Picoamp, the response of the MZM, and added jitter from the time-tagger. Thus, the results show that the Picoshort and Picoamp are a viable replacement to conventional bulky pulse generators, and are suitable for scalable quantum networks using PPSs.

### Third Example: Characterization Results

The quantum network setup was characterized by measuring the effect of Raman noise introduced by the optical clock pulses and quantifying the timing drift and jitter of the optical clock distribution system. The role of noise is captured by the [symbol] of the photon pairs, [symbol] = [symbol] / [symbol] , where, in the absence of noise, [symbol] corresponds to the coincidence detection rate of photons originating from the same event, whereas [symbol] corresponds to the coincidence detection rate of photons originating from different events. Note that in this context, the [symbol] is equivalent to the cross-correlation function [symbol] ⁽²⁾ [14]. Dark counts and Raman scattering can reduce [symbol] as a noise detection event may be recorded instead of a photon. Furthermore, lack of a timing reference will also reduce [symbol] as [symbol] events will not be distinguished from [symbol] events. Our method is well-suited for quantum networks as channel loss ensures accidental coincidences.

Our PPS produces a pair with a probability of 1%(˜1/ [symbol] as measured at the output of the PPS) per pulse [15]. Channel loss, calculated by taking the ratio of the coincidence rates to the single photon detection rates [15], from PPLN waveguide to the SNSPDs are 24 dB and 26 dB, which are equivalent to ˜120 km and ˜130 km lengths of single-mode fiber, respectively.

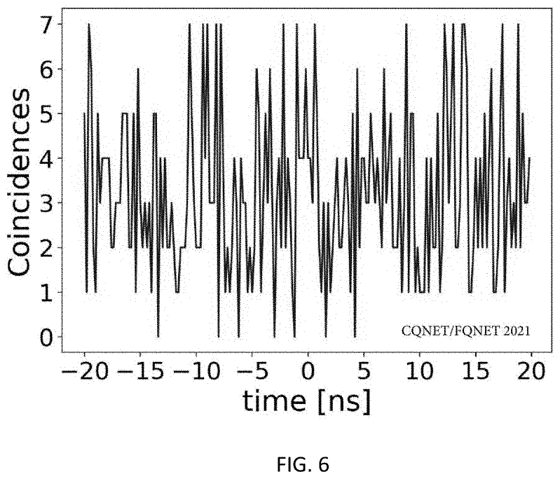

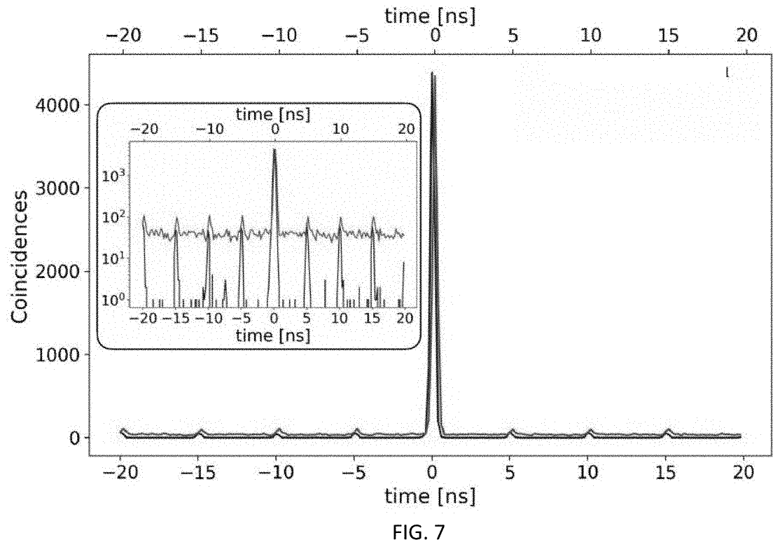

The arrival time difference of SNSPD detection events at Rx1 and Rx2 was measured over 5 minutes in three configurations: (i) without any clock distribution system enabled, (ii) with the optical clock distribution enabled, and (iii) by blocking the optical clock pulses and performing clock distribution with electronic pulses. Experiment (i) is performed to unambiguously show that a clock distribution is required, whereas experiments (ii) and (iii) clearly demonstrate the impact of the Raman noise introduced by the optical clock pulses. The histograms of detection events for configuration (i) is shown in FIG. 6 whereas (ii) and (iii) are shown in FIG. 7.

The detection events were summed over a 200 ps interval around the peak at zero time delay to calculate [symbol] , whereas the average number of detection events in a 200 ps interval around each of the accidental peaks is used to determine [symbol] .

The measurements yield [symbol] ˜1, [symbol] =77±12, and [symbol] =42±2 for scenarios (i), (ii), and (iii), respectively. Indeed, without the clock distribution (i) we simply measure noise, but with either the optical (ii) or electronic (iii) clock distribution enabled we measure [symbol] . well above the classical limit of 2. To place our results into context for qubit distribution, if these photon pairs were to be time-bin entangled, e.g. using the approach demonstrated in Ref. [9], and if no other imperfections play a role, the measured reduction of [symbol] from the Raman noise suggests a reduction of fidelity [symbol] / [symbol] +1) [16] from 99% to 98% or the same reduction in the entanglement visibility ( [symbol] −1)/( [symbol] +1) [17]. This visibility is well-above the ⅓ required for non-separability of a Werner state [18] and the non-locality bound of 1/\sqrt{2} [19]. Thus, the noise introduced by our optical clock distribution system according to one or more embodiments described herein plays a minimal role in our quantum network.

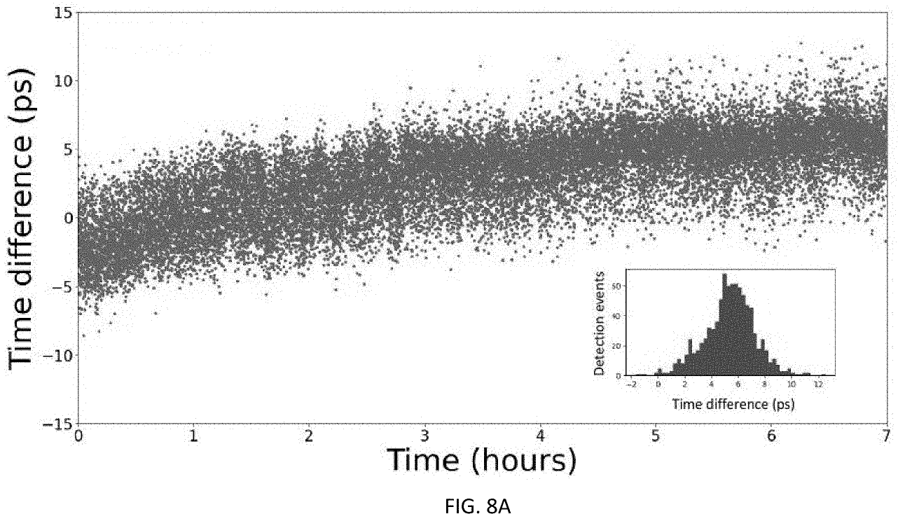

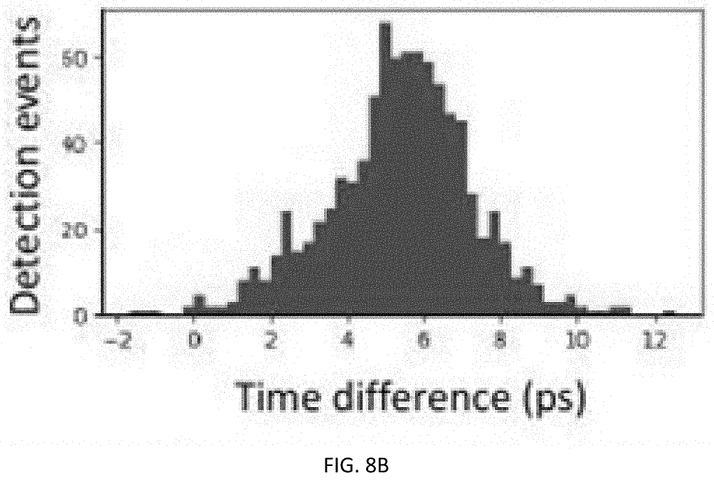

The timing drift and jitter of our optical clock distribution system was also determined. Specifically, the arrival time of the clock pulses at Rx1 and Rx2 (after the AnyClockRx1 and AnyClockRx2 oscillators) were measured using an oscilloscope, finding a timing jitter of 2 ps over a timescale of 60 s, and a time difference that slowly drifts by 5 ps over 7 h owing to fiber length variations, see FIG. 8. Note that we use an oscilloscope because the current configuration of the TDC adds up to 7 ps timing jitter, but with a standard upgrade this can be as low as 3 ps [20]. Since the clock pulses are attenuated to ensure a minimal reduction in [symbol] , our measurement is limited by the noise floor of detectors only. Nevertheless, the timing jitter of our clock distribution currently sets an upper-bound on our distribution rate of ˜300 MHz, which is sufficient for quantum networks spanning a few hundred kilometers, that is, metro-scale or inter-city networks.

Advantages and Improvements

Despite not constituting the optimal choice of wavelength, our telecommunication O-band synchronization system introduces little noise into our telecommunication C-band quantum network. The low noise is partially due to the strong spectral filtering of the photons at the FBGs—a required step to ensure the photons are purified, i.e. spectral correlations are removed. This renders the photons suitable for two-photon interference, as required for implementations of advanced network protocols, e.g. based on quantum teleportation [9]. Note that the 768 nm light remaining after the SPDC step is far off-resonant from the 1536 nm photons, and is partially filtered by the long fiber spools, MUX/DEMUX filters, fiber Bragg gratings, and SNSPD devices, thus it does not contribute any measurable noise to the network. Further reduction of noise in our system can be afforded by detecting the clock pulses with more sensitive REC detectors, thus allowing a reduction of the clock pulse intensity. To this end, SNSPDs operating in the O-band could be used, and would constitute minimal system overhead given that C-band SNSPDs are already deployed. This would also result in improvements to the system clock rate as SNSPDs feature timing jitters as low as a few ps [21], which constitutes an upper-bound of a few hundred GHz to the clock rate (note that the impact of the dead time of the SNSPDs is negligible due to channel loss). Although this rate cannot be reached by our current implementation, we expect that clock rates of a few GHz can be achieved simply by using a GHz-bandwidth REC photodiode and exchanging our AnyClocks with stabilized GHz-frequency oscillators and accompanying phase control circuits. To ensure there is no reduction in [symbol] these rates, it is likely fine-tuning of the impedance matching of electronic circuits and between components is necessary, along with using higher-bandwidth FBG filters and MZMs. In addition, the [symbol] could be improved if the clock pulses are transmitted in the telecommunication Lband ˜1.6 μm), or if the PPS operated at a wavelength that is blue shifted from the clock, e.g. in the O-band while operating the clock in the C-band. Nonetheless, the C-band features the lowest loss in standard single-mode fiber used for long-haul networks (0.18 dB/km), whereas the O-band is a commonly used channel with a wavelength range that matches those of available off-the-shelf telecommunication components (e.g. lasers, modulators, MUX/DEMUXs, detectors, etc.). Overall, our three-node quantum network and accompanying synchronization system sheds light on the role of noise in quantum networking and constitutes a step towards practical, as well as high-rate, classical-quantum co-existing networks.

### Fourth Example: Process Steps for Manufacturing Synchronization System

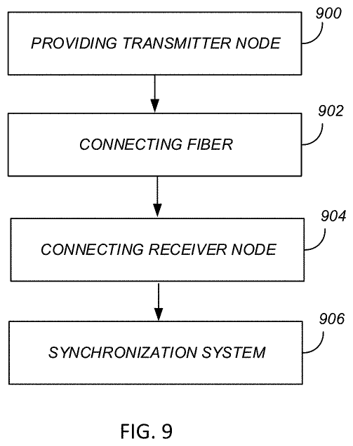

FIG. 9 illustrates a method of making a system for synchronizing photons and/or clocks in different nodes, in a communication system (e.g., telecom link, quantum teleportation network or a hybrid telecommunication network, e.g., connected by fibers transmitting signals using electromagnetic radiation).

Block 900 represents providing a transmitter node comprising a photon source outputting signal photons used to teleport one or more qubits, wherein the signal photons comprise one or more first wavelengths; a transmitter clock outputting one or more clock pulses comprising electromagnetic radiation having one or more second wavelengths, wherein the one or more first wavelengths are red shifted as compared to the one or more second wavelengths; and a multiplexer distributing at least one multiplexed signal, comprising one of the signal photons and one of the clock pulses.

Block 902 represents connecting the transmitter node to at least one fiber for transmission to at least one receiver node in the quantum teleportation network.

The clock pulses comprise an intensity below a threshold such that Raman scattering of the one of the clock pulses by the at least one fiber, shifting the one or more second wavelengths to the one or more first wavelengths of the one of signal photons, is negligible, and

Block 904 represents connecting the receiver node comprising a demultiplexer demultiplexing the one of the signal photons and the one of the clock pulses; a first detector detecting the one of the signal photons; and a second detector detecting the one of the clock pulses.

Block 906 represents the end result, a synchronization system which may optionally be coupled to a quantum teleportation system or quantum link. Devices and systems according to embodiments of the present invention include, but are not limited to, the following examples.
1. A system 100, 292 for synchronizing photons (e.g., signal photons 104, 106) and/or clocks in different nodes in a communication link or network (e.g., quantum teleportation network 1600, 290, 150 or a hybrid telecommunication network), comprising:

a transmitter node (Node 1) comprising:

a photon source (e.g., PPS) outputting signal photons 104, 106 (or pulses comprising photons) used to teleport one or more qubits, wherein the signal photons comprise one or more first wavelengths;

a transmitter clock (AnyclockTx, 108) outputting one or more clock pulses 110, 112 comprising electromagnetic radiation having one or more second wavelengths, wherein the one or more first wavelengths are red shifted (longer wavelength) as compared to the one or more second wavelengths; and

a multiplexer (MUX) distributing at least one multiplexed signal 202, comprising one of the signal photons and one of the clock pulses, to at least one fiber 114 for transmission to at least one receiver node (Node 2, Node 3) in the quantum teleportation network, wherein the clock pulses comprise an intensity below a threshold such that Raman scattering of the one of the clock pulses by the at least one fiber 114, shifting the one or more second wavelengths to the one or more first wavelengths of the one of signal photons, is negligible or below a threshold level, or reduced or suppressed, and

the receiver node comprising:
a demultiplexer (DEMUX) demultiplexing the one of the signal photons and the one of the clock pulses;
a first detector (e.g., SPD) detecting the one of the signal photons; and
a second detector (DET) detecting the one of the clock pulses.
2. The system of example 1, wherein the at least one receiver node comprises: a circuit (TDC2) detecting a time difference between:
a first arrival time of the one of the signal photons detected by the first detector (SPD), and
a second arrival time of the one of the clock pulses detected by the second detector (DET), e.g., so that the time difference can be determined with an accuracy/resolution of 10 picoseconds or less (e.g. 1 ps≤accuracy/resolution≤10 ps, or 3 ps≤accuracy/resolution≤7 ps), or so that a synchronization between the one of the signal photons and the one of the clock pulses can be determined at less than 10 picosecond level (time resolution at which time difference is determined); and a receiver clock 116 synchronizing to the transmitter clock using the time difference.
3. The system of example 2, wherein receiver node further comprises:

a spectral filter (e.g., FBG) purifying the one of the signal photons by removing spectral correlations, so as to form a purified photon 204 enabling two photon interference 1604 of the purified photon with an additional photon 1602, as characterized by observation of a Hong-Ou-Mandel effect or performance of a Bell State Measurement; and

the first detector comprises a single photon detector (e.g., SNSPD, PD1, PD2) detecting the purified photon and outputting a signal electrical pulse 206 in response thereto.
4. The system of example 2 or 3, wherein the receiver node further comprises:

the second detector DET comprising a photodiode (REC) outputting an electrical signal 208 in response to detecting the one of the clock pulses;

an amplifier (AMP) amplifying the electrical signal;

a voltage oscillator 210 connected to the amplifier so that the electrical signal adjusts a phase of the voltage oscillator outputting a clock electrical pulse; and

a time to digital converter circuit (TDC2) determining the time difference between the signal electrical pulse and the clock electrical pulse.
5. A data acquisition (DAQ) and control system of any of the examples 1-4 connected to the transmitter node and the receiver node for logging the time difference.
6. The system of any of the examples 1-5, comprising:

a plurality of the at least one fiber (hereinafter fibers 114a, 114b) connecting the transmitter node (NODE 1) to a plurality of the at least one receiver node (hereinafter receiver nodes Node 2, Node 3), wherein the at least one multiplexer distributes a plurality of the at least one multiplexed signal 202 (hereinafter multiplexed signals 202a, 202b), each of the multiplexed signals distributed to a different one of the fibers 114a, 114b connecting between the transmitter node (Node 1) and a different one of the receiver nodes (Node 2 or Node 3).
7. The system of any of the examples 1-6, further comprising:

the at least one fiber 114 (e.g., optical fiber, or fiber transmitting electromagnetic radiation) comprising:

a first fiber 114a connecting the transmitter node (node 1) to the at least one receiver node comprising a first receiver node (node 2), and

a second fiber 114b connecting the transmitter node to the at least one receiver node comprising a second receiver node (Node 3),

the at least one multiplexed signal 202 comprising a first multiplexed signal 202a transmitted in the first fiber and a second multiplexed signal 202b transmitted in the second fiber; and

the signal photons comprising entangled photons comprising a first entangled photon 104 entangled with a second entangled photon 106, wherein the one of the signal photons 104 in the first multiplexed signal 202a comprises the first entangled photon and the one of the signal photons 106 in the second multiplexed signal 202b comprises the second entangled photon.
8. A teleportation system 1600, quantum link 1600, 290, 150 or quantum network, 1600, 150 comprising the system of any of the examples 1-7, wherein at least one of the transmitter node (node 1), the first receiver node (node 2), or the second receiver node (node 3) comprise a two-photon interferometer 1602 for interfering the first entangled photon 104 or the second entangled photon 106, carrying one of the qubits, with another photon 1602 carrying another qubit, so as to perform a Bell State Measurement.
9. The system of any of the examples 1-8, wherein the Raman scattering is suppressed such that a timing jitter of the clocks 108,106 in the different nodes, or the clocks in the different nodes are synchronized to within 5 picoseconds or less or 10 picoseconds or less (i.e., each of the clocks 108, 110 have the same timing T to within 5 ps or less or 10 ps or less, e.g., 10 ns ≤T≤5 ps or 10 ns ≤T≤5 ps or 1 ps ≤T≤10 ps) and/or the signal photons can be correctly identified using the associated clock photons/pulses 110, 112.
10. The system of any of the examples 1-9, wherein the hybrid telecommunication network 1600 comprises a classical computer 1000 or classical communication network and quantum telecommunication network/quantum teleportation network/quantum link 150, 1600, 290.
11. The system of any of the examples 1-10, wherein the Raman scattering is suppressed or negligible such that teleportation of the one or more qubits (and/or message using the qubit) is successful at a clock rate of 200 MHz (or a clock rate in a range of 1-1000 MHz) or at a desired data transmission rate or clock rate, or when the clock pulses 110, 112, signal photons 104, 106, and/or multiplexed signals 202 are transmitted at a frequency F of 200 MHz, or a frequency in a range of 1-1000 MHz, or 1 MHz-1000 GHz e.g.1 MHz,≤F≤1000 GHz).
12. The system of any of the examples 8-11, wherein the at least one of the transmitter node (node 1), the first receiver node (node 2), or the second receiver node (node 3) comprise a two-photon interferometer 1602 for interfering the first entangled photon 104 or the second entangled photon 106, carrying the one or more qubits, with another photon 1602 carrying another qubit (carrying a message), so as to perform a Bell State Measurement.
13. The system of example 1 and 2, an optionally any one or more of the examples 3-12 wherein the Raman scattering is below a threshold level, or reduced or suppressed such that the time difference can be determined with an accuracy/resolution of 10 picoseconds or less (e.g. 1 ps≤accuracy/resolution≤10 ps, or 3 ps≤accuracy/resolution≤7 ps).
14. The system of any of the examples, wherein the fiber 114 comprises an optical fiber, a fiber transmitting electromagnetic radiation comprising the signal photons and the clock pulses, e.g., having wavelengths (e.g., telecom wavelengths) transmittable through the fiber.
15. The system of any of the examples 1-14, wherein the signal photons comprise a first signal photon 104 and a second signal photon 106.
16. The system of any of the examples, comprising signal pulses of electromagnetic radiation, comprising a first signal pulse comprising the first signal photon 104 and a second signal pulse comprising the second signal photon 106.
17. The system of any of the examples, wherein the clock pulses comprise a first clock pulse 110 comprising a first clock photon and a second clock pulse 112 comprising a second clock photon.

### Fifth Example: Hardware Environment

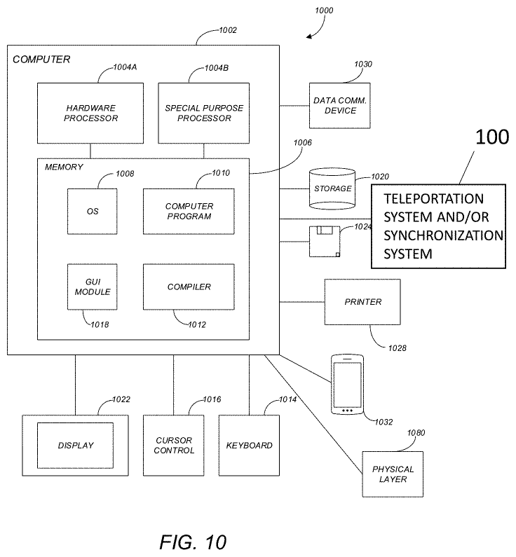

FIG. 10 is an exemplary hardware and software environment 1000 (referred to as a computer-implemented system and/or computer-implemented method) used to implement one or more embodiments of the invention and which may be connected to the teleportation system 100, e.g., as may be used for performing the benchmarking. In one or more examples, computer system may comprise or be coupled to a physical layer 1080. The hardware and software environment includes a computer 1002 and may include peripherals. Computer 1002 may be a user/client computer, server computer, or may be a database computer. The computer 1002 comprises a hardware processor 1004A and/or a special purpose hardware processor 1004B (hereinafter alternatively collectively referred to as processor 1004) and a memory 1006, such as random access memory (RAM). The computer 1002 may be coupled to, and/or integrated with, other devices, including input/output (I/O) devices such as a keyboard 1014, a cursor control device 1016 (e.g., a mouse, a pointing device, pen and tablet, touch screen, multi-touch device, etc.) and a printer 1028. In one or more embodiments, computer 1002 may be coupled to, or may comprise, a portable or media viewing/listening device 1032 (e.g., IPAD, portable digital video player, cellular device, personal digital assistant, etc.). In yet another embodiment, the computer 1002 may comprise a multi-touch device, mobile phone, gaming system, or internet enabled device executing on various platforms and operating systems.

In one embodiment, the computer 1002 operates by the hardware processor 1004A performing instructions defined by the computer program 1010 (e.g., a control or benchmarking application) under control of an operating system 1008. The computer program 1010 and/or the operating system 1008 may be stored in the memory 1006 and may interface with the user and/or other devices to accept input and commands and, based on such input and commands and the instructions defined by the computer program 1010 and operating system 1008, to provide output and results.

Output/results may be presented on the display 1022 or provided to another device for presentation or further processing or action. In one embodiment, the display 1022 comprises a liquid crystal display (LCD) having a plurality of separately addressable liquid crystals. Alternatively, the display 1022 may comprise a light emitting diode (LED) display having clusters of red, green and blue diodes driven together to form full-color pixels. Each liquid crystal or pixel of the display 1022 changes to an opaque or translucent state to form a part of the image on the display in response to the data or information generated by the processor 1004 from the application of the instructions of the computer program 1010 and/or operating system 1008 to the input and commands. The image may be provided through a graphical user interface (GUI) module 1018. Although the GUI module 1018 is depicted as a separate module, the instructions performing the GUI functions can be resident or distributed in the operating system 1008, the computer program 1010, or implemented with special purpose memory and processors.

In one or more embodiments, the display 1022 is integrated with/into the computer 1002 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, etc.), touch tables, and walls (e.g., where an image is projected through acrylic and/or glass, and the image is then backlit with LEDs).

Some or all of the operations performed by the computer 1002 according to the computer program 1010 instructions may be implemented in a special purpose processor 1004B. In this embodiment, some or all of the computer program 1010 instructions may be implemented via firmware instructions stored in a read only memory (ROM), a programmable read only memory (PROM) or flash memory within the special purpose processor 1004B or in memory 1006. The special purpose processor 1004B may also be hardwired through circuit design to perform some or all of the operations to implement the present invention. Further, the special purpose processor 1004B may be a hybrid processor, which includes dedicated circuitry for performing a subset of functions, and other circuits for performing more general functions such as responding to computer program 1010 instructions. In one embodiment, the special purpose processor 1004B is an application specific integrated circuit (ASIC) or Field Programmable Gate Array (FPGA).

The computer 1002 may also implement a compiler 1012 that allows an application or computer program 1010 written in a programming language such as C, C++, Assembly, SQL, PYTHON, PROLOG, MATLAB, RUBY, RAILS, HASKELL, or other language to be translated into processor 1004 readable code. Alternatively, the compiler 1012 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1010 accesses and manipulates data accepted from I/O devices and stored in the memory 1006 of the computer 1002 using the relationships and logic that were generated using the compiler 1012.

The computer 1002 also optionally comprises an external communication device such as a modem, satellite link, Ethernet card, or other device for accepting input from, and providing output to, other computers 1002.

In one embodiment, instructions implementing the operating system 1008, the computer program 1010, and the compiler 1012 are tangibly embodied in a non-transitory computer-readable medium, e.g., data storage device 1020, which could include one or more fixed or removable data storage devices, such as a zip drive, floppy disc drive 1024, hard drive, CD-ROM drive, tape drive, etc. Further, the operating system 1008 and the computer program 1010 are comprised of computer program 1010 instructions which, when accessed, read and executed by the computer 1002, cause the computer 1002 to perform the steps necessary to implement and/or use the present invention or to load the program of instructions into a memory 1006, thus creating a special purpose data structure causing the computer 1002 to operate as a specially programmed computer executing the method steps described herein. Computer program 1010 and/or operating instructions may also be tangibly embodied in memory 1006 and/or data communications devices 1030, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 902.

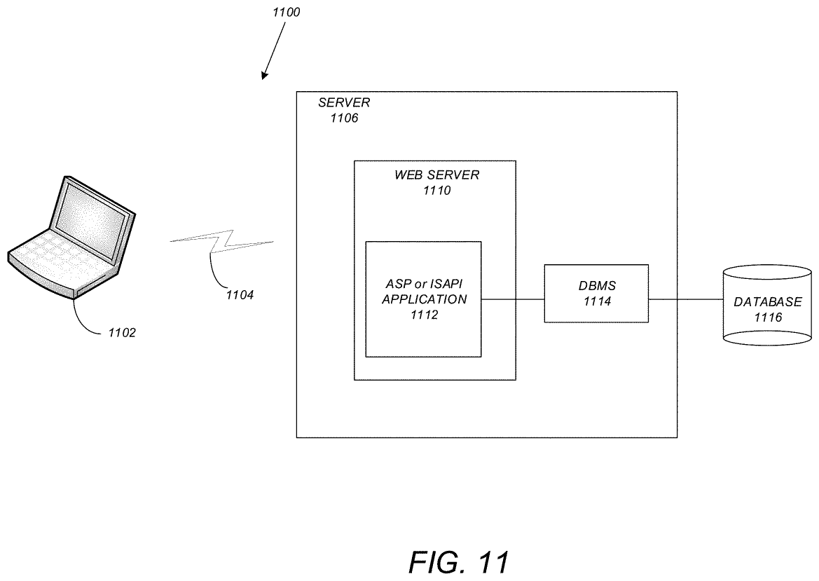

FIG. 11 schematically illustrates a typical distributed/cloud-based computer system 1100 using a network 1104 to connect client computers 1102 to server computers 1106. A typical combination of resources may include a network 1104 comprising the Internet, LANs (local area networks), WANs (wide area networks), SNA (systems network architecture) networks, or the like, clients 1102 that are personal computers or workstations (as set forth in FIG. 10), and servers 1106 that are personal computers, workstations, minicomputers, or mainframes (as set forth in FIG. 10). However, it may be noted that different networks such as a cellular network (e.g., GSM [global system for mobile communications] or otherwise), a satellite based network, or any other type of network may be used to connect clients 1102 and servers 1106 in accordance with embodiments of the invention.

A network 1104 such as the Internet connects clients 1102 to server computers 1106. Network 1104 may utilize ethernet, coaxial cable, wireless communications, radio frequency (RF), etc. to connect and provide the communication between clients 1102 and servers 1106. Further, in a cloud-based computing system, resources (e.g., storage, processors, applications, memory, infrastructure, etc.) in clients 1102 and server computers 1106 may be shared by clients 1102, server computers 1106, and users across one or more networks. Resources may be shared by multiple users and can be dynamically reallocated per demand. In this regard, cloud computing may be referred to as a model for enabling access to a shared pool of configurable computing resources.

Clients 1102 may execute a client application or web browser and communicate with server computers 1106 executing web servers 1110. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1102 may be downloaded from server computer 1106 to client computers 1102 and installed as a plug-in or ACTIVEX control of a web browser. Accordingly, clients 1102 may utilize ACTIVEX components/component object model (COM) or distributed COM (DCOM) components to provide a user interface on a display of client 1102. The web server 1110 is typically a program such as MICROSOFT'S INTERNET INFORMATION SERVER.

Web server 1110 may host an Active Server Page (ASP) or Internet Server Application Programming Interface (ISAPI) application 1112, which may be executing scripts. The scripts invoke objects that execute business logic (referred to as business objects). The business objects then manipulate data in database 1116 through a database management system (DBMS) 1114. Alternatively, database 1116 may be part of, or connected directly to, client 1102 instead of communicating/obtaining the information from database 1116 across network 1104. When a developer encapsulates the business functionality into objects, the system may be referred to as a component object model (COM) system. Accordingly, the scripts executing on web server 1110 (and/or application 1112) invoke COM objects that implement the business logic. Further, server 1106 may utilize MICROSOFT'S TRANSACTION SERVER (MTS) to access required data stored in database 1116 via an interface such as ADO (Active Data Objects), OLE DB (Object Linking and Embedding DataBase), or ODBC (Open DataBase Connectivity).

Generally, these components 1100-1116 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1102 and 1006 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1002 and 1006. Embodiments of the invention are implemented as a software application on a client 1002 or server computer 1006. Further, as described above, the client 1002 or server computer 1006 may comprise a thin client device or a portable device that has a multi-touch-based display. The whole teleportation system 100 (like the physical layer of the current Internet) can be operated under a control plane layer which is directed/orchestrated by the applications layer on top. Based on the needs of the client who interacts with the application layer, the necessary requirements of the application are input to the control plane layer which will appropriately reconfigure various above-mentioned devices involved in the teleportation system 100. When sufficiently efficient quantum transducers (devices which can interconvert from photons to microwaves) are developed, the teleportation systems 100 via interaction with these transducers will help scaling the networks to continental scale, increasing the computing power by inter-connecting different quantum computers.

### Sixth Example: Example Method of Making a Pulse Shortener

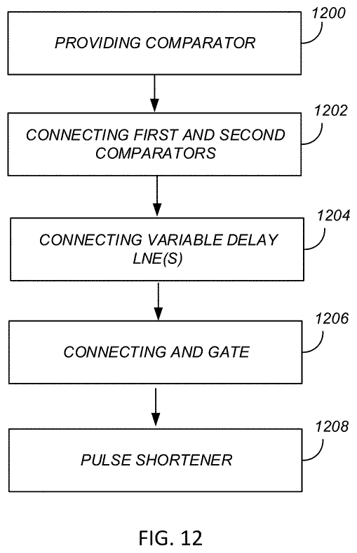

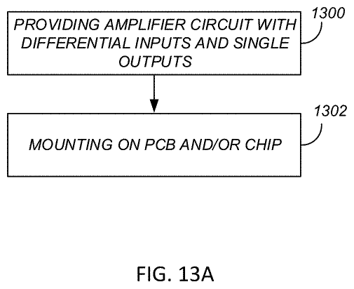

FIG. 12 illustrates a method of making a pulse shortener, comprising the following steps.

Block 1200 represents obtaining a first comparator comparing an input pulse, having a FWHM in a range of 1-100 ns, with a threshold so as to output:

a first signal if the input signal has a greater amplitude than the threshold, or

a second signal if the input signal has a smaller amplitude than the threshold.

Block 1202 represents connecting a second comparator and a third comparator connected to the first comparator, wherein the second comparator outputs a first polarity signal in response to the first signal and the third comparator outputs a second polarity signal in response to the second signal, wherein the first polarity signal and the second polarity signal have equal magnitude but opposite polarity;

Block 1204 represents connecting a variable delay line to the second comparator and the third comparator, wherein the variable delay line:
has a dynamic range and/or resolution of less than 100 ps (e.g., 10 nanoseconds≤resolution≤100 ps and/or dynamic range of 1 ps≤dynamic range≤1000 ps or 1 ps≤dynamic range≤100 ps or), and
combines the first polarity signal and the second polarity signal with variable overlap to form an output pulse.

Block 1206 represents connecting an AND gate to the variable delay line, wherein the AND gate has a rise and fall time of less than 10 ps (e.g., 1 ns≤rise time or fall time≤10 ps) modulating the output pulse to form a shortened pulse having a full width at a half maximum in a range of 25 ps—100 ps (25 ps≤FWHM≤100 ps).

Block 1208 represents the end result, a pulse shortener 300 as illustrated in FIG. 3 comprising:

a first comparator (A) comparing an input pulse 210, having a FWHM in a range of 1-100 ns (e.g., 1 ns≤FWHM≤100 ns), with a threshold so as to output:

a first signal if the input pulse (e.g., clock signal) has a greater amplitude than the threshold, or

a second signal if the input pulse has a smaller amplitude than the threshold;

a second comparator (B) and a third comparator (B′) connected to the first comparator, wherein the second comparator outputs a first polarity signal in response to the first signal and the third comparator outputs a second polarity signal in response to the second signal, wherein the first polarity signal and the second polarity signal have equal magnitude but opposite polarity;

one or more variable delay lines (C, C′) connected to the second comparator and the third comparator, wherein each of the variable delay lines:
optionally has a dynamic range and resolution of less than 100 picoseconds (ps), and
combines the first polarity signal and the second polarity signal with variable overlap to form an output pulse; and

an AND gate (A) connected to the variable delay line, wherein the AND gate has a rise and fall time of less than 10 ps modulating the output pulse to form a shortened pulse having a full width at a half maximum (FWHM) in a range of 25 ps -100 ps (25 ps≤FWHM≤100 ps).

### Seventh Example Method of Making an Amplifier

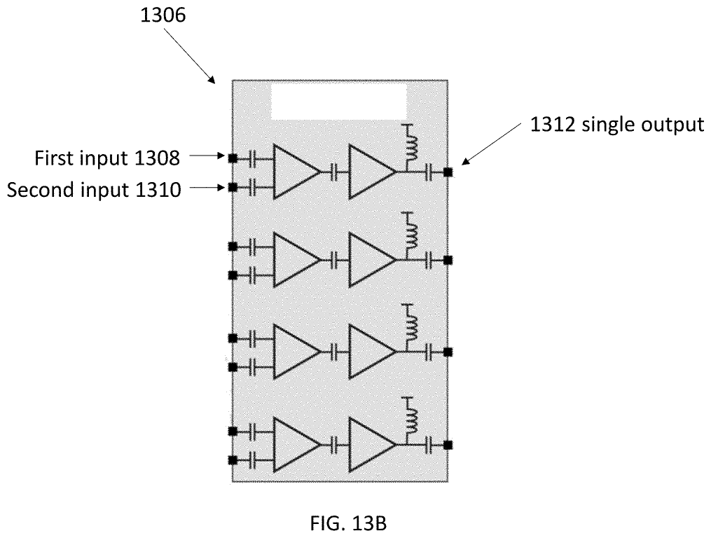

FIG. 13A illustrates a method of making an amplifier 1306 as illustrated in FIG. 13B, comprising the following steps.

Block 1300 represents providing an amplifier circuit 1306 (e.g., differential amplifier, e.g., comprising an operational amplifier) comprising differential inputs, the differential inputs comprising a first input 1308 and a second input 1310, and a single output 1312. The amplifier circuit is configured to amplify an electrical pulse (e.g. as outputted from PUSH) having a duration D in a range of 1-1000 ps (1 ps≤D≤1000 ps), received at the first input, into a modulation voltage pulse at the single output 1312, and the modulation voltage has a full width and half maximum (FWHM) less than 100 ps and an amplitude comprising a pi voltage of a Mach Zehnder Modulator (MZM). The amplifier for the synchronization system described herein is a high performance linear quad channel MZ modulator driver IC. The Amplifier takes a differential input signal that can range up to 600 mVpp differential to provide a single ended output that can range up to 6 Vpp. In addition, this driver has very low power consumption of 1.1 Watt at 4 Vpp output and low RMS jitter degradation.

Block 1302 represents optionally mounting on a PCB or a chip. The step may comprise optionally fabricating a plurality of the amplifiers on a chip, so that the chip comprises a plurality of the differential inputs and a plurality of the single outputs, wherein each of the single outputs output the modulation voltage in response to the electrical pulse received at the first input of the corresponding amplifier.

### Eighth Example: Method of Making a Driver Circuit

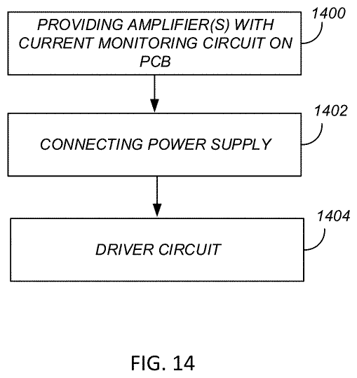

FIG. 14 illustrates a method of making a driver circuit for driving multiple Mach Zehnder Modulators (MZM). The method comprises the following steps.

Block 1400 represent providing one or more printed circuit boards comprising the amplifiers of the seventh example, a current monitoring system, an analog to digital converter, and a digital to analog converter for controlling a gain, a zero-voltage crossing, and an undershoot of the electrical pulse. The printed circuit board further comprises a plurality of output tracks for connecting each of the single outputs to a different one of the MZMs and a pair of input tracks for connecting to the first input and the second input.

Block 1402 represents connecting a power supply for powering the driver circuit. The power supply for the amplifier chip 1306 used in the synchronization system described herein consists of 4 independent channels for independent differential to single ended amplification. Each channel consists of 3 stages of amplification where each one requires a specific biasing voltage and biasing current; the current can be controlled with the gate voltage. In order to maintain the amplifier within specs, the different currents should be monitored and then the voltage be set accordingly.

Block 1404 represents the end result, a driver circuit 500 as illustrated in FIG. 5 for driving multiple Mach Zehnder Modulators (MZM), comprising one or more printed circuit boards 502 comprising the amplifiers, one or more power supplies 504 for powering the driver circuit; a current monitoring system 506, an analog to digital converter 508, and a digital to analog converter 510 for controlling a gain, a zero-voltage crossing, and an undershoot of the electrical pulse; a plurality of output tracks 512 for connecting each of the single outputs to a different one of the MZMs; two input tracks 514 for connecting to the first input and the second input. For the power supply, the biasing voltage and biasing current for each amplifier stage depends on the desired gain, and the measured zero-voltage crossing and an undershoot of the electrical pulse being amplified

### Ninth Example: Method of Making an Entangle Photon Pair Source

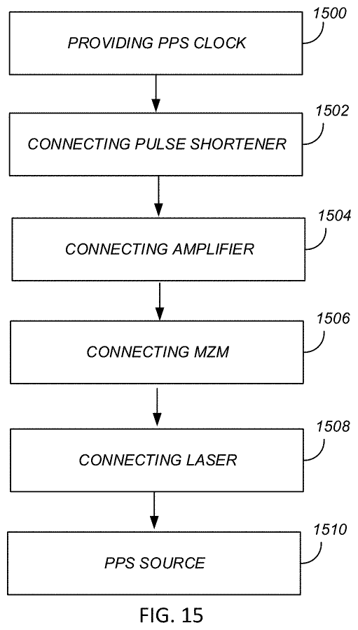

FIG. 15 illustrates a method of making an entangled photon pair source (PPS) comprising the following steps.

Block 1500 represents providing a PPS clock outputting a PPS clock pulse.

Block 1502 represents providing a pulse shortener (e.g., as described in the sixth example) shortening a duration the PPS clock pulse so as to form a shortened pulse having a FWHM of less than 100 ps (e.g., 1 ps≤.FWHM≤100 ps)

Block 1504 represents providing an amplifier (e.g., as described in the seventh example) amplifying the shortened pulse to an amplitude corresponding to a desired modulation voltage of a Mach Zehnder Modulator (MZM).

Block 1506 represents providing the MZM coupled to the amplifier and a CW laser outputting CW electromagnetic radiation, wherein the modulation voltage applied to the MZM controls modulation of the CW electromagnetic radiation by the MZM to form picosecond pulses of the electromagnetic radiation having a duration in a range of 1-100 ps.

Block 1508 represents providing a non-linear crystal outputting entangled photons in response to each of the picosecond pulses.

Block 1510 represents the end result, an entangled photon pair source (PPS) as illustrated in FIG. 2 comprising a PPS clock (e.g., AnyclockTX or the clock 110 in FIG. 1) outputting a PPS clock pulse 210; a pulse shortener (PUSH in FIG. 2, e.g., 300 as illustrated in FIG. 3) shortening a duration the PPS clock pulse so as to form a shortened pulse having a FWHM of less than 100 ps (e.g., 1 ps≤FWHM≤100 ps); an amplifier (AMP, 1306) amplifying the shortened pulse to an amplitude corresponding to a desired modulation voltage of a Mach Zehnder Modulator (MZM); the MZM coupled to the amplifier (AMP) and a CW laser (C-Las) outputting CW electromagnetic radiation, wherein the modulation voltage applied to the MZM controls modulation of the CW electromagnetic radiation by the MZM to form picosecond pulses of the electromagnetic radiation having a duration in a range of 1-100 ps (e.g., 1 ps≤D≤100 ps); and a non-linear crystal (PPLN) outputting entangled photons in response to each of the picosecond pulses.

### Tenth Example: Quantum Teleportation System or Quantum Link

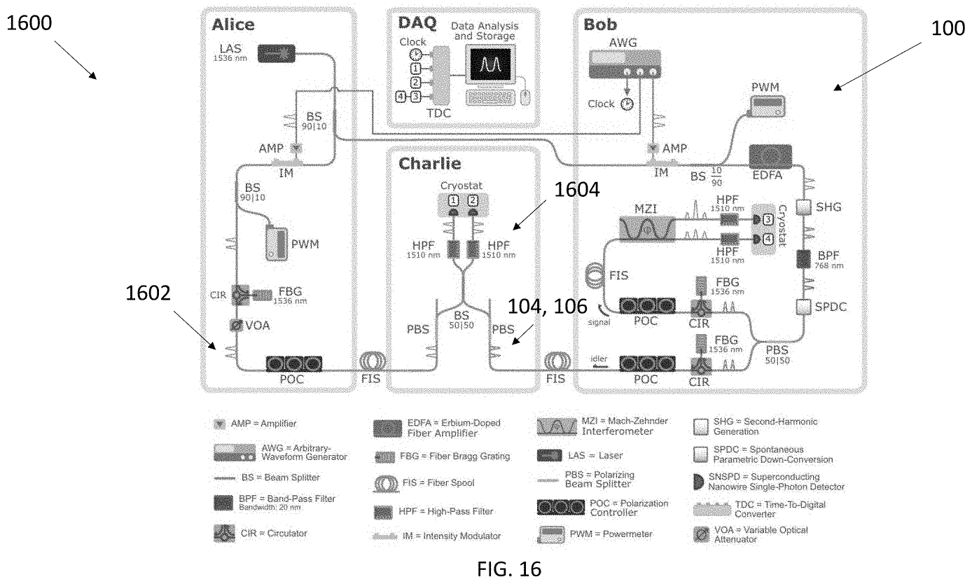

FIG. 16 illustrates a quantum teleportation system 1600 comprising or coupled to the synchronization system 100, 292 described herein, comprising:

a source of pairs of entangled photons (PPS), each pair comprising a first photon (signal photon, 104) entangled with a second photon (idler, signal photon 106), wherein the first photon carries a first time bin qubit (Bob qubit) in an entangled state;

one or more filters spectrally filtering the entangled photons;

a first attenuator attenuating a pulse of radiation including a third photon 1602 carrying a second time bin qubit (Alice qubit);

a second filter spectrally filtering the pulse of radiation to increase indistinguishability between the third photon and the entangled photons;

a transmitter including:

a beam splitter BS (in interferometer 1604) interacting the third photon 1602 carrying the second qubit (Alice qubit) with the first photon (signal 104 or 106) carrying the first qubit (Bob qubit); and

a pair of detectors detecting photons outputted from the beamsplitter so as to perform a Bell state measurement of the quantum system comprising the first qubit and the second qubit;

a receiver connected to the source of entangled photons via an optical fiber, the receiver including a detection system connected to the optical fiber, the detection system detecting the second photon transmitted along the optical fiber and reading a state of the second qubit (Alice qubit) using the Bell State Measurement communicated from the transmitter;

a clock distribution system (e.g., synchronization system 100, 292) outputting a clock signal 110, 112 synchronizing the arrival times of the first photon (signal) and the third photon (alice) on the beamsplitter with the detection of the second photon in the receiver in the same clock cycle (e.g, with picosecond/nanosecond or less resolution);

a data acquisition system:
tagging the arrival times of the first photon and the third photon on the beams splitter and the second photon on the receiver (e.g., at GHz rate or higher); and
measuring (e.g., at a gigahertz rate or higher) a mean number of first photons and the second photons outputted from the source of entangled photons and a mean number of the third photons (Alice photons) in the pulse of radiation outputted from the first attenuator; and

a classical computer benchmarking the quantum teleportation system in real time using outputs comprising the arrival times and/or the mean number of photons measured by the data acquisition system.

For example, the node 1 (e.g., transmitter node) in the synchronization system 100, 292 can be Alice or Bob, so that the signal photons transmitting the message can be the first photon from Bob or the third photon from Alice, and the receiver node (Node 2 or Node 3) can be Alice (if Bob the transmitter) or Bob (if Alice the transmitter) using Charlie. Further information on such teleportation systems can be found in [22-23].

In one embodiment, the synchronization system 100, 292 and quantum teleportation system 1600, comprise

a transmitter (Alice) generating first photons 1602;

a source of pairs of entangled photons (PPS), each pair comprising a second photon (signal photon 104) entangled with a third photon (signal photon 106);

a coupler 1604, BSs electromagnetically coupled to the transmitter and the source of pairs of entangled photons;

a pair of detectors D1 and D2 electromagnetically coupled to the coupler;

a receiver (node 2 or node 3 at Bob) including a detection system comprising a detector D3 detecting the third photons;

an optical fiber 114 connecting the detector D3 and the source of pairs of entangled photons, wherein the detector D3 detects the third photons transmitted along the optical fiber;

a clock distribution system 108, 100, 292 outputting one or more clock signals 110, 112 controlling timing of the first photons, the second photons, and the third photons such that:
the coupler 1604, BS interacts one of the first photons 1602, carrying a first qubit, and one of the second photons 104, carrying a second qubit, to form an interference;
the pair of detectors D1 and D2 detect the interference used to obtain a Bell State Measurement of a quantum system comprising the first qubit and the second qubit;
the detector D3 detects one of the third photons 106 entangled with the one of the second photons 104 and outputs a signal in response thereto; and
the detection system reads a state of the first qubit using the signal and the Bell State Measurement.

The teleportation system may optionally comprise a data acquisition system DAQ acquiring arrival times of the first photons and the second photons at the detectors D1 and D2, and the arrival times of the third photons at the detector D3, wherein the arrival times are tagged with reference to the clock signals so that one or more sets of photons may be identified, each set comprising the one of the first photons, the one of the second photons, and the one of the third photons.

The teleportation system may optionally comprise a computer 1000 benchmarking the quantum teleportation system in real time using the arrival times, wherein the benchmarking comprises using a model simulating at least one of teleportation fidelity of the first qubit teleported to the one of the third photons received at the detector D3, or a degree of indistinguishability between the one of the first photons and the one of the second photons, as a function of a mean number of the second photons, wherein the model is calibrated and validated using experimental measurements of the teleportation fidelity and the degree of indistinguishability

### REFERENCES

The following references are incorporated by reference herein.
[1] A. Tanaka, M. Fujiwara, S. W. Nam, Y. Nambu, S. Takahashi, W. Maeda, K. ichiro Yoshino, S. Miki, B. Baek, Z. Wang, A. Tajima, M. Sasaki, and A. Tomita, “Ultra fast quantum key distribution over a 97 km installed telecom fiber with wavelength division multiplexing clock synchronization,” Opt. Express, vol. 16, no. 15, pp. 11354-11360, July 2008.
[2] Y.-L. Tang, H.-L. Yin, S.-J. Chen, Y. Liu, W.-J. Zhang, X. Jiang, L. Zhang, J. Wang, L.-X. You, J.-Y. Guan, D.-X. Yang, Z. Wang, H. Liang, Z. Zhang, N. Zhou, X. Ma, T.-Y. Chen, Q. Zhang, and J. W. Pan, “Field test of measurement-device-independent quantum key distribution,” IEEE Journal of Selected Topics in Quantum Electronics, vol. 21, no. 3, pp. 116-122, 2015.
[3] R. Valivarthi, Q. Zhou, G. H. Aguilar, V. B. Verma, F. Marsili, M. D. Shaw, S. W. Nam, D. Oblak, W. Tittel et al., “Quantum teleportation across a metropolitan fibre network,” Nature Photonics, vol. 10, no. 10, pp. 676-680, 2016.
[4] Q.-C. Sun, Y.-L. Mao, S.-J. Chen, W. Zhang, Y.-F. Jiang, Y.-B. Zhang, W.-J. Zhang, S. Miki, T. Yamashita, H. Terai et al., “Quantum teleportation with independent sources and prior entanglement distribution over a network,” Nature Photonics, vol. 10, no. 10, pp. 671-675, 2016.
[5] R. Valivarthi, P. Umesh, C. John, K. A. Owen, V. B. Verma, S. W. Nam, D. Oblak, Q. Zhou, and W. Tittel, “Measurement-device-independent quantum key distribution coexisting with classical communication,” Quantum Science and Technology, vol. 4, no. 4, p. 045002, 2019.
[6] J. Williams, M. Suchara, T. Zhong, H. Qiao, R. Kettimuthu, and R. Fukumori, “Implementation of quantum key distribution and quantum clock synchronization via time bin encoding,” in Quantum Computing, Communication, and Simulation, P. R. Hemmer and A. L. Migdall, Eds., vol. 11699, International Society for Optics and Photonics. SPIE, 2021, pp. 16-25.
[7] I. Choi, R. J. Young, and P. D. Townsend, “Quantum key distribution on a 10 gb/s wdm-pon,” Opt. Express, vol. 18, no. 9, pp. 9600-9612, April 2010.
[8] K. Patel, J. Dynes, I. Choi, A. Sharpe, A. Dixon, Z. Yuan, R. Penty, and A. Shields, “Coexistence of high-bit-rate quantum key distribution and data on optical fiber,” Physical Review X, vol. 2, no. 4, p. 041010, 2012.
[9] R. Valivarthi, S. I. Davis, C. Peña, S. Xie, N. Lauk, L. Narváez, J. P. Allmaras, A. D. Beyer, Y. Gim, M. Hussein et al., “Teleportation systems toward a quantum internet,” PRX Quantum, vol. 1, no. 2, p. 020317, 2020.
[10] “Tektronix,” https//www.tek.com/en/products/arbitrary-waveform-generators/, accessed: 2022-03-09.
[11] “Shf,” https.//www.shf-communication.com/products/rf-broadband-amplifiers/, accessed: 2022-03-09.
[12] M. Garbati, E. Perret, R. Siragusa, and C. Halopé, “Ultra-low-jitter fully tunable baseband pulse generator for uwb applications,” IEEE Transactions on Microwave Theory and Techniques, vol. 66, no. 1, pp. 420-430, 2017.
[13] Y. Liu, T.-Y. Chen, L.-J. Wang, H. Liang, G.-L. Shentu, J. Wang, K. Cui, H.-L. Yin, N.-L. Liu, L. Li, X. Ma, J. S. Pelc, M. M. Fejer, C.-Z. Peng, Q. Zhang, and J.-W. Pan, “Experimental measurement-deviceindependent quantum key distribution,” Phys. Rev. Lett., vol. 111, p. 130502, September 2013.
[14] R. Loudon, The quantum theory of light. Oxford, 2000.
[15] I. Marcikic, H. de Riedmatten, W. Tittel, V. Scarani, H. Zbinden, and N. Gisin, “Time-bin entangled qubits for quantum communication created by femtosecond pulses,” Phys. Rev. A, vol. 66, p. 062308, December 2002.
[16] H. Takesue and K. Inoue, “1.5-μm band quantum-correlated photon pair generation in dispersion-shifted fiber: suppression of noise photons by cooling fiber,” Opt. Express, vol. 13, no. 20, pp. 7832-7839, October 2005.
[17]—“Generation of 1.5 -μm band time-bin entanglement using spontaneous fiber four-wave mixing and planar light-wave circuit interferometers,” Phys. Rev. A, vol. 72, p. 041804, October 2005.
[18] R. F. Werner, “Quantum states with einstein-podolsky-rosen correlations admitting a hidden-variable model,” Phys. Rev. A, vol. 40, pp. 42774281, October 1989.
[19] J. F. Clauser, M. A. Home, A. Shimony, and R. A. Holt, “Proposed experiment to test local hidden-variable theories,” Phys. Rev. Lett., vol. 23, pp. 880-884, October 1969.
[20] “Qutag,” https://gutools.com/time-tagger, accessed: 2022-03-09.
[21] B. Korzh, Q.-Y. Zhao, J. P. Allmaras, S. Frasca, T. M. Autry, E. A. Bersin, A. D. Beyer, R. M. Briggs, B. Bumble, M. Colangelo, G. M. Crouch, A. E. Dane, T. Gerrits, A. E. Lita, F. Marsili, G. Moody, C. Peña, E. Ramirez, J. D. Rezac, N. Sinclair, M. J. Stevens, A. E. Velasco, V. B. Verma, E. E. Wollman, S. Xie, D. Zhu, P. D. Hale, M. Spiropulu, K. L. Silverman, R. P. Mirin, S. W. Nam, A. G. Kozorezov, M. D. Shaw, and K. K. Berggren, “Demonstration of sub-3 ps temporal resolution with a superconducting nanowire single-photon detector,” Nature Photonics, vol. 14, no. 4, pp. 250-255, April 2020.
[22] Teleportation Systems Toward a Quantum Internet Raju Valivarthi, Samantha I. Davis, Christián Peña Si Xie, Nikolai Lauk, Lautaro Narváez Jason P. Allmaras, Andrew D. Beyer, Yewon Gim, Meraj Hussein, George Iskander, Hyunseong Linus Kim, Boris Korzh, Andrew Mueller, Mandy Rominsky, Matthew Shaw, Dawn Tang, Emma E. Wollman, Christoph Simon, Panagiotis Spentzouris, Daniel Oblak, Neil Sinclair, and Maria Spiropulu PRX Quantum 1, 02,0317—Published 4 December 2020/DOI:https://doi.org/10.1103/PRXQuantum.1.020317.
[23] U.S. patent application Ser. No. 18/073,245 filed Dec. 1, 2022, by Maria Spiropulu and Venkata Ramana Raju Valivarthi, entitled “TELEPORTATION SYSTEMS TOWARD A QUANTUM INTERNET,” which application claims the benefit under 35 USC 119(e) of co-pending and commonly assigned U.S. Provisional Patent Application Ser. No. 63/285,782, filed Dec. 3, 2021, by Maria Spiropulu and Venkata Ramana Raju Valivarthi, entitled “TELEPORTATION SYSTEMS TOWARD A QUANTUM INTERNET,” (CIT-8635).
R. Valivarthi et al., “Picosecond Synchronization System for Quantum Networks,” in Journal of Lightwave Technology, 2022, doi: 10.1109/JLT.2022.3194860;
https://arxiv.org/pdf/2203.03127.pdf;
arXiv:2203.03127 [quantph] (or arXiv:2203.03127v1 [quant-ph] for this version) https://doi.org/10.48550/arXiv.2203.03127

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system for synchronizing photons in a quantum teleportation network or a hybrid telecommunication network, comprising:
a transmitter node comprising:
a photon source outputting signal photons used to teleport one or more qubits, wherein the signal photons comprise one or more first wavelengths;
a transmitter clock outputting one or more clock pulses comprising electromagnetic radiation having one or more second wavelengths, wherein the one or more first wavelengths are red shifted as compared to the one or more second wavelengths; and
a multiplexer distributing at least one multiplexed signal, comprising one of the signal photons and one of the clock pulses, to at least one fiber for transmission to at least one receiver node in the quantum teleportation network, wherein the clock pulses comprise an intensity below a threshold such that Raman scattering of the one of the clock pulses by the at least one fiber, shifting the one or more second wavelengths to the one or more first wavelengths of the one of signal photons, is negligible or suppressed, and
the at least one receiver node comprising:
a demultiplexer demultiplexing the one of the signal photons and the one of the clock pulses;
a first detector detecting the one of the signal photons; and
a second detector detecting the one of the clock pulses.

2. The system of claim 1, wherein the at least one receiver node comprises:
a circuit detecting a time difference between:
a first arrival time of the one of the signal photons detected by the first detector, and
a second arrival time of the one of the clock pulses detected by the second detector, so that the time difference can be determined with an accuracy/resolution of 10 picoseconds or less; and
a receiver clock synchronizing to the transmitter clock using the time difference.

3. The system of claim 2, wherein receiver node further comprises:
a spectral filter purifying the one of the signal photons by removing spectral correlations, so as to form a purified photon enabling two photon interference of the purified photon with an additional photon, as characterized by observation of a Hong-Ou-Mandel effect or performance of a Bell State Measurement; and
the first detector comprises a single photon detector detecting the purified photon and outputting a signal electrical pulse in response thereto.

4. The system of claim 3, wherein the receiver node further comprises:
the second detector comprising a photodiode outputting an electrical signal in response to detecting the one of the clock pulses;
an amplifier amplifying the electrical signal;
a voltage oscillator connected to the amplifier so that the electrical signal adjusts a phase of the voltage oscillator outputting a clock electrical pulse; and
a time to digital converter circuit determining the time difference between the signal electrical pulse and the clock electrical pulse.

5. A data acquisition and control system connected to the transmitter node and the receiver node of claim 2 for logging the time difference.

6. The system of claim 1, comprising:
a plurality of the at least one fiber (hereinafter fibers) connecting the transmitter node to a plurality of the at least one receiver node (hereinafter receiver nodes), wherein the at least one multiplexer distributes a plurality of the at least one multiplexed signal (hereinafter multiplexed signals), each of the multiplexed signals distributed to a different one of the fibers connecting between the transmitter node and a different one of the receiver nodes.

7. The system of claim 1, further comprising:
the at least one fiber comprising:
a first fiber connecting the transmitter node to the at least one receiver node comprising a first receiver node, and
a second fiber connecting the transmitter node to the at least one receiver node comprising a second receiver node,
the at least one multiplexed signal comprising a first multiplexed signal transmitted in the first fiber and a second multiplexed signal transmitted in the second fiber; and
the signal photons comprising entangled photons comprising a first entangled photon entangled with a second entangled photon, wherein the one of the signal photons in the first multiplexed signal comprises the first entangled photon and the one of the signal photons in the second multiplexed signal comprises the second entangled photon.

8. A teleportation system, quantum link, or quantum network comprising the system of claim 7, wherein at least one of the transmitter node, the first receiver node, or the second receiver node comprise a two-photon interferometer for interfering the first entangled photon or the second entangled photon, carrying one of the qubits, with another photon carrying another qubit, so as to perform a Bell State Measurement.

9. A pulse shortener, comprising:
a first comparator comparing an input pulse, having a FWHM in a range of 1-100 ns (1 ns≤FWHM≤100 ns), with a threshold so as to output:
a first signal if the input pulse has a greater amplitude than the threshold, or
a second signal if the input pulse has a smaller amplitude than the threshold;
a second comparator and a third comparator connected to the first comparator, wherein the second comparator outputs a first polarity signal in response to the first signal and the third comparator outputs a second polarity signal in response to the second signal, wherein the first polarity signal and the second polarity signal have equal magnitude but opposite polarity;
a variable delay line connected to the second comparator and the third comparator, wherein the variable delay line combines the first polarity signal and the second polarity signal with variable overlap to form an output pulse; and
an AND gate connected to the variable delay line, wherein the AND gate has a rise and fall time of less than 10 ps modulating the output pulse to form a shortened pulse having a full width at a half maximum in a range of 25 ps≤FWHM≤100 ps.

10. One or more amplifiers, each of the amplifiers comprising:
differential inputs, comprising a first input and a second input; and
a single output; and wherein:
the each of the amplifiers is configured to amplify an electrical pulse having a duration D in a range of 1≤D≤1000 ps, received at the first input, into a modulation voltage pulse at the single output, and
the modulation voltage pulse has a FWHM less than 100 ps and an amplitude comprising a pi voltage of a Mach Zehnder Modulator (MZM).

11. A chip comprising a plurality of the amplifiers of claim 10, comprising the differential inputs and a plurality of the single outputs, wherein each of the single outputs output the modulation voltage pulse in response to the electrical pulse received at the first input.

12. A driver circuit for driving multiple Mach Zehnder Modulators (MZM), comprising the amplifiers of claim 11:
one or more printed circuit boards comprising:
the amplifiers of claim 11,
one or more power supplies for powering the driver circuit;
a current monitoring system, an analog to digital converter, and a digital to analog converter for controlling a gain, a zero-voltage crossing, and an undershoot of the electrical pulse;
a plurality of output tracks for connecting each of the single outputs to a different one of the MZMs;
two input tracks for connecting to the first input and the second input.

13. An entangled photon pair source (PPS), comprising the pulse shortener of claim 9, the PPS further comprising:
a PPS clock outputting a PPS clock pulse;
a pulse shortener shortening a duration the PPS clock pulse so as to form a shortened pulse having a FWHM of less than 100 ps;
an amplifier amplifying the shortened pulse to an amplitude corresponding to a desired modulation voltage of a Mach Zehnder Modulator (MZM);
the MZM coupled to the amplifier and a CW laser outputting continuous wave (CW) electromagnetic radiation, wherein the modulation voltage applied to the MZM controls modulation of continuous (CW) electromagnetic radiation by the MZM to form picosecond pulses of the electromagnetic radiation having a duration D in a range of 1≤D≤100 ps; and
a non-linear crystal (e.g., PPLN, periodically poled lithium niobate) outputting entangled photons in response to each of the picosecond pulses.

14. The entangled photon pair source of claim 13, wherein the amplifier comprises:
differential inputs, comprising a first input and a second input; and
a single output; and wherein:
the amplifier is configured to amplify an electrical pulse having a duration D in a range of 1≤D≤1000 ps, received at the first input, into a modulation voltage pulse at the single output, and
the modulation voltage has a FWHM less than 100 ps and an amplitude comprising a pi voltage of a Mach Zehnder Modulator (MZM).

15. The system of claim 1, wherein the photon source comprises an entangled photon pair source comprising:
a PPS clock outputting a PPS clock pulse;
a pulse shortener shortening a duration the PPS clock pulse so as to form a shortened pulse having a FWHM of less than 100 ps;
an amplifier amplifying the shortened pulse to an amplitude corresponding to a desired modulation voltage of a Mach Zehnder Modulator (MZM);
the MZM coupled to the amplifier and a CW laser outputting continuous wave (CW) electromagnetic radiation, wherein the modulation voltage applied to the MZM controls modulation of the CW electromagnetic radiation by the MZM to form picosecond pulses of the electromagnetic radiation having a duration D in a range of 1≤D≤100 ps; and
a non-linear crystal outputting entangled photons in response to each of the picosecond pulses.
and the transmitter clock comprises the PPS clock.

16. The system of claim 16, wherein the amplifier comprises:
differential inputs, comprising a first input and a second input; and
a single output; and wherein:
the amplifier is configured to amplify an electrical pulse having a duration D in a range of 1≤D≤1000 ps, received at the first input, into a modulation voltage pulse at the single output, and
the modulation voltage pulse has a FWHM less than 100 ps and an amplitude comprising a pi voltage of a Mach Zehnder Modulator (MZM); and
the pulse shortener comprises:
a first comparator comparing an input pulse, having a FWHM in a range of 1-100 ns, with a threshold so as to output:
a first signal if the input signal has a greater amplitude than the threshold, or a second signal if the input signal has a smaller amplitude than the threshold;
a second comparator and a third comparator connected to the first comparator, wherein the second comparator outputs a first polarity signal in response to the first signal and the third comparator outputs a second polarity signal in response to the second signal, wherein the first polarity signal and the second polarity signal have equal magnitude but opposite polarity;
a variable delay line connected to the second comparator and the third comparator, wherein the variable delay line combines the first polarity signal and the second polarity signal with variable overlap to form an output pulse; and
an AND gate connected to the variable delay line, wherein the AND gate has a rise and fall time of less than 10 ps modulating the output pulse to form a shortened pulse having a full width at a half maximum in a range of 25 ps≤FWHM≤100 ps.

17. The system of claim 1, wherein the signal photons comprise the first wavelengths in a telecommunications C band and the clock pulses comprise the second wavelengths in a telecommunications 0 band.

18. The system of claim 1, wherein the Raman scattering is suppressed such that a timing jitter of clocks in the different nodes is, or the transmitter clock and receiver clocks in the receiver nodes are synchronized to, within 5 picoseconds or less and/or the signal photons can be correctly identified using the clock pulses.

19. The system of claim 2, wherein the circuit detects the time difference so that the time difference can be determined with an accuracy of 10 picoseconds or less.
